(19) United States
(12) Patent Application Publication
(10) Pub. No.: US 2018/0181269 A1
(43) Pub. Date: Jun. 28, 2018

(54) SYSTEMS AND METHODS FOR ONLINE-CONTENT AND PRINT-CONTENT ASSEMBLY

(71) Applicant: tronc, Inc., Chicago, IL (US)

(72) Inventors: James Perez, Los Angeles, CA (US); Honest Charley Bodkin, Los Angeles, CA (US); Benjamin Leonard Welsh, Los Angeles, CA (US); Evan Wagstaff, Los Angeles, CA (US); Lily Mazet Mihalik, Los Angeles, CA (US)

(21) Appl. No.: 15/836,166

(22) Filed: Dec. 8, 2017

Related U.S. Application Data
(60) Provisional application No. 62/438,645, filed on Dec. 23, 2016.

(51) Int. Cl. G06F 3/0483; H04L 29/06; H04L 12/58; H04L 12/24

(52) U.S. Cl. CPC G06F 3/0483; H04L 41/0273; H04L 51/04; H04L 63/083

(57) ABSTRACT

In an embodiment, a content assembly platform (CAP) presents a structured user interface arranged for structured receipt of authored content. The CAP receives content for a content piece via the structured user interface. The CAP presents the received content via the structured user interface according to a set of predetermined content-display rules. The CAP stores the received content in a content management system (CMS) for online publication of the content piece according to the predetermined set of content-display rules. The CAP receives an instruction to publish the content piece to a print-production system, and responsively packages the received content in a print-production-system-readable format and transmits the packaged content to the print-production system.

### CROSS-REFERENCE TO RELATED APPLICATIONS

This application claims benefit of U.S. Provisional application No. 62/438,645, filed Dec. 23, 2016 and entitled “Systems and Methods for Online-Content and Print-Content Assembly” which is hereby incorporated by reference in its entirety.

### BACKGROUND

Today's content producers (e.g., reporters, editors, copy editors, authors, publishers, journalists, artists, illustrators, proofers, developers, designers, managers, project managers, website developers, curators, webmasters, content-producing entities, and/or the like) and content consumers (e.g., readers, viewers, subscribers, customers, and/or the like) are living and working in an increasingly technological age. Computers, mobile devices, and Internet communication are virtually ubiquitous in modern society. As a result, it is becoming increasingly common for content to be published online and subsequently consumed online, for example, by the content producers and the content consumers, respectively.

More and more, today's content producers and content consumers can access the Internet in a variety of environments and on a variety of devices. Today's content producers may work in environments that are equipped with Internet access, be it by way of wired (typically Ethernet) and/or wireless (typically Wi-Fi) connections. Quite often, today's content consumers and content producers consume and produce online content, respectively, using web browsers and/or other applications (apps) running on what are referred to herein as computing-and-communication devices (CCDs), and indeed consume and/or produce online content quite often using web browsers and/or other apps running on a certain type of CCD that is referred to herein as a client device. Some example client devices include desktop computers, laptops, tablets, cell phones, smart phones, personal digital assistants (PDAs), and/or the like.

Content consumers typically access online content for consumption using their respective client devices (and/or client devices that are available at locations such as coffee shops, Internet cafes, schools, libraries, kiosks, airports, and/or the like). The electronic data communications that are involved in the accessing of such content typically traverse one or more packet-switched data networks such as cellular networks, Wi-Fi networks, the Internet, and/or the like, and are typically conducted using, among other data-communication protocols, the network-layer (i.e., layer 3 of the Open Systems Interconnected (OSI) reference model (a.k.a. the OSI stack)) protocol known as the Internet Protocol (IP), usually together with a transport-layer (i.e., layer-4) protocol such as the Transmission Control Protocol (TCP) or the User Datagram Protocol (UDP), as examples.

Today's content producers typically employ content-production tools and/or carry out content-production processes to generate content. Although some of today's content producers exclusively or primarily generate content for online consumption (e.g., BuzzFeed, Vox, .Mic to name a few), some other of today's content producers generate content for online publication and also generate (the same or different) content for print publication. Content producers' content-production workflow, as well as content consumers' engagement with and/or enjoyment of such content, may be affected by the content-production tools employed and/or processes carried out by the content producers to generate the content. And of course, numerous other affects may result from the content-production tools employed (and/or content-production processes carried out) to produce content. It is desirable for content producers to improve the efficiency of content-production workflow, as well as to generate content that is more engaging and/or enjoyable to consumers.

### OVERVIEW OF CERTAIN DISCLOSED EMBODIMENTS

Disclosed herein are systems and methods for online-content and print-content assembly.

One embodiment takes the form of a method carried out by a content assembly platform (CAP). The method includes presenting a structured user interface (SUI) arranged for structured receipt of authored content. The method also includes receiving content for a content piece via the SUI. The method also includes presenting the received content via the SUI according to a set of predetermined content-display rules. The method also includes storing the received content in a content management system (CMS) for online publication of the content piece according to the set of predetermined content-display rules. The method also includes receiving an instruction to publish the content piece to a print-production system (PPS), and responsively packaging the received content in a PPS-readable format and transmitting the packaged content to the PPS.

In at least one embodiment, the structured user interface interacts with the CMS via a CMS-agnostic application programming interface (API).

In at least one embodiment, the structured user interface includes separate first and second regions; the first region includes multiple data-entry elements for respectively receiving different aspects of the content piece; and the received content is uneditably presented in the second region according to the predetermined content-display rules. Such embodiments are referred to for brevity and clarity in the ensuing paragraphs as separate-regions embodiments.

In at least one separate-regions embodiment, the multiple data-entry elements include at least one data-entry field.

In at least one separate-regions embodiment, the multiple data-entry elements include at least one data-entry widget.

In at least one embodiment, a messaging application is integrated with the structured user interface. Such embodiments are referred to for brevity and clarity in the ensuing paragraphs as messaging-application embodiments.

In at least one messaging-application embodiment, the method further includes receiving a workflow command via the structured user interface, and responsively transmitting an associated workflow message via the integrated messaging application. In at least one such messaging-application embodiment, transmitting the associated workflow message via the integrated messaging application comprises transmitting the associated workflow message via a content-appropriate channel provided by the integrated messaging application.

In at least one messaging-application embodiment, the method further includes obtaining an integrated-messaging-application-generated token for user authentication; and authenticating a user with the integrated messaging application one or more times using the obtained token.

In at least one embodiment, each content piece is uniquely identified within the CAP by a unique identifier. Such embodiments are referred to for brevity and clarity in the ensuing paragraphs as unique-identifier embodiments.

In at least one unique-identifier embodiment, the unique identifier is an alphanumeric slug. In at least one such unique-identifier embodiment, the alphanumeric slugs conform to a workflow-shaping convention. In at least one such unique-identifier embodiment, the respective slug for a given content piece identifies a corresponding news desk for the given content piece.

In at least one embodiment, the method further includes receiving a trim indication for the content piece via the structured user interface, wherein packaging the received content in the print-production-system-readable format comprises including the received trim indication in the packaged content.

In at least one embodiment, the print-production-system-readable format is an XML format. In one such embodiment, transmitting the packaged content to the print-production system comprises using Simple Object Access Protocol (SOAP) communication to transmit the packaged content to the print-production system.

In at least one embodiment, the CAP carries out the packaging and transmitting steps multiple iterative times to provide rolling updates of the content piece to the print-production system; in at least one such embodiment, each rolling update comprises a complete copy of the updated content piece.

In at least one embodiment, the method further includes receiving a print-production-sever command via the structured user interface and responsively transmitting a print-production-severed instruction to the print-production system.

In at least one embodiment, the CAP is also integrated with a budgeting system.

In at least one embodiment, the structured user interface is configured to receive identifiers of audio and/or visual content items for embedding in the content piece.

Another embodiment takes the form of a CAP. The CAP is configured to output for presentation a SUI arranged for structured receipt of authored content. The CAP is configured to receive content for a content piece via the SUI. The CAP is configured to output for presentation the received content via the SUI according to a set of predetermined content-display rules. The CAP is configured to submit the received content in a CMS for online publication of the content piece according to the set of predetermined content-display rules. The CAP is configured to receive an instruction to publish the content piece to a PPS, and responsively package the received content in a PPS-readable format and transmit the packaged content to the PPS.

Another embodiment takes the form of a CAP. The CAP includes a controller module. The CAP includes a PPS communication module. The CAP includes a SUI module that is configured to: present a SUI arranged for structured receipt of authored content; receive content for a content piece via the SUI; present the received content via the SUI according to a set of predetermined content-display rules; and provide the received content to the controller module. The CAP includes a CMS communication module that is configured to: receive the received content from the controller module; and transmit the received content to a CMS for online publication of the content piece according to the predetermined set of content-display rules, wherein the controller module is configured to receive the received content from the SUI module; provide the received content to the CMS communication module; receive an instruction to publish the content piece to a PPS, and responsively provide the received content to the PPS communication module, wherein the PPS communication module is configured to responsively: receive the received content from the controller module; package the received content in a PPS-readable format; and transmit the packaged content to the PPS.

In at least one embodiment, the structured user interface interacts with the CMS via a CMS-agnostic API.

In at least one embodiment, the structured user interface includes separate first and second regions; the first region includes multiple data-entry elements for respectively receiving different aspects of the content piece; and the SUI module is configured to uneditably present the received content in the second region according to the predetermined content-display rules. In at least one such embodiment, the multiple data-entry elements include at least one data-entry field. In at least one such embodiment, the multiple data-entry elements include at least one data-entry widget. In at least one such embodiment, the multiple data-entry elements include at least one data-entry field. In at least one other such embodiment, the multiple data-entry elements include at least one data-entry widget.

In at least one embodiment, a messaging application is integrated with the structured user interface.

In at least one embodiment where a messaging application is integrated with the structured user interface, the CAP further includes a messaging application (MA) communication module, the SUI module is further configured to receive a workflow command via the structured user interface, the controller module is further configured to receive the received workflow command from the SUI module and responsively provide the received workflow command to the messaging application communication module, and the MA communication module is configured to responsively transmit an associated workflow message via the integrated messaging application. In at least one such embodiment, the MA communication module being configured to transmit the associated workflow message via the integrated messaging application includes being configured to transmit the associated workflow message via a content-appropriate channel provided by the integrated messaging application. In at least one other such embodiment, the messaging application communication module is configured to: obtain an integrated-messaging-application-generated token for user authentication; and authenticate a user with the integrated messaging application one or more times using the obtained token.

In at least one embodiment, each content piece is uniquely identified within the CAP by a unique identifier. In at least one such embodiment, the unique identifier is an alphanumeric slug. In at least one such embodiment, the alphanumeric slugs conform to a workflow-shaping convention. In at least one such embodiment, the respective slug for a given content piece identifies a corresponding news desk for the given content piece.

In at least one embodiment, the SUI module is further configured to receive a trim indication for the content piece via the structured user interface, and the PPS communication module is further configured to include the received trim indication in the packaged content.

In at least one embodiment, the PPS-readable format is an XML format. In at least one such embodiment, the PPS communication module is further configured to use Simple Object Access Protocol (SOAP) communication to transmit the packaged content to the PPS.

In at least one embodiment, the PPS communication module is further configured to, multiple iterative times, provide rolling updates of the content piece to the PPS. In at least one such embodiment, each rolling update comprises a complete copy of the updated content piece.

In at least one embodiment, the SUI module is further configured to receive a print-production-sever command via the structured user interface, and the PPS communication module is further configured to responsively transmit a print-production-severed instruction to the print-production system.

In at least one embodiment, the CAP is also integrated with a budgeting system.

In at least one embodiment, the SUI is configured to receive identifiers of audio and/or visual content items for embedding in the content piece.

Moreover, any of the variations and permutations described above and/or anywhere else in this disclosure can be implemented with respect to any embodiments, including with respect to any method embodiments and with respect to any system embodiments. Furthermore, this flexibility and cross-applicability of embodiments is present in spite of the use of slightly different language (e.g., process, method, steps, functions, set of functions, and the like) to describe and/or characterize such embodiments.

Furthermore, the above-listed overview of disclosed embodiments is meant to be illustrative and is not meant to be exhaustive, comprehensive, or otherwise limiting. Those of skill in the relevant art will understand this and will further understand that variations and modifications of the above-listed embodiments, and indeed of any of the disclosed embodiments, can be made without departing from the spirit or scope of the present disclosure.

### BRIEF DESCRIPTION OF THE DRAWINGS

FIG. 1 depicts an example communication system, which includes an example content assembly platform (CAP), an example print-production system (PPS) and an example content management system (CMS), in accordance with at least one embodiment.

FIG. 2 depicts an example computing-and-communication device (CCD), in accordance with at least one embodiment.

FIG. 3A depicts an example simplified arrangement of the example communication system of FIG. 1 and explicitly depicts an example structured user interface (SUI), in accordance with at least one embodiment.

FIG. 3B depicts an example architecture of the example CAP of FIG. 1, in accordance with at least one embodiment.

FIG. 4A depicts the example simplified arrangement of the example communication system of FIG. 3A and additionally includes the example PPS of FIG. 1 and the example CMS of FIG. 1, in accordance with at least one embodiment.

FIG. 4B depicts another example architecture of the example CAP of FIG. 1, in accordance with at least one embodiment.

FIG. 5 depicts the example SUI, in accordance with at least one embodiment.

FIG. 6 depicts a first example screenshot of the SUI presented by the CAP of FIG. 1, in accordance with at least one embodiment.

FIG. 7 depicts a second example screenshot of the SUI presented by the CAP of FIG. 1, in accordance with at least one embodiment.

FIG. 8 depicts a third example screenshot of the SUI presented by the CAP of FIG. 1, in accordance with at least one embodiment.

FIG. 9 depicts a fourth example screenshot of the SUI presented by the CAP of FIG. 1, in accordance with at least one embodiment.

FIG. 10 depicts a fifth example screenshot of the SUI presented by the CAP of FIG. 1, in accordance with at least one embodiment.

FIG. 11 depicts a sixth example screenshot of the SUI presented by the CAP of FIG. 1, in accordance with at least one embodiment.

FIG. 12 depicts a seventh example screenshot of the SUI presented by the CAP of FIG. 1, in accordance with at least one embodiment.

FIG. 13A depicts an example a writer-alert window of the SUI presented by the CAP of FIG. 1, in accordance with at least one embodiment.

FIG. 13B depicts an example line-edit alert window of the SUI presented by the CAP of FIG. 1, in accordance with at least one embodiment

FIG. 13C depicts an example copy-desk-alert window of the SUI presented by the CAP of FIG. 1, in accordance with at least one embodiment.

FIG. 14 depicts an eighth example screenshot of the SUI presented by the CAP of FIG. 1, in accordance with at least one embodiment.

FIG. 15A depicts a ninth example screenshot of the SUI presented by the CAP of FIG. 1, in accordance with at least one embodiment.

FIG. 15B depicts a tenth example screenshot of the SUI presented by the CAP of FIG. 1, in accordance with at least one embodiment.

FIG. 16 depicts an eleventh example screenshot of the SUI presented by the CAP of FIG. 1, in accordance with at least one embodiment.

FIG. 17 depicts a twelfth example screenshot of the SUI presented by the CAP of FIG. 1, in accordance with at least one embodiment.

FIG. 18 depicts a method, in accordance with at least one embodiment.

Before proceeding with this detailed description, it is noted that the entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—can only properly be read as being constructively preceded by a clause such as “In at least one embodiment . . . .” And it is for reasons akin to brevity and clarity of presentation that this implied leading clause is not repeated ad nauseam in the below detailed description of the drawings.

### DETAILED DESCRIPTION

Creating content for publishing may involve a variety of content producers who may be responsible for completing a variety of tasks before a content piece is ready to publish. For example, in a content-production environment such as a newsroom, content producers such as reporters, editors, and copyeditors, among others, may attempt to work collaboratively to assemble a content piece, or a portion of a content piece, for publishing. Such collaboration may lead to various complications. Additional and/or alternative complications may arise when creating content for both online and print publication. Some conventional tools and techniques employed by content producers for assembling content for online and print publication result in task redundancies which may lead to workflow inefficiencies and/or increase a likelihood of error(s). For example, when employing some such conventional tools, to assemble content to be published online and in print, a content producer may be required to copy changes to a content piece in one tool (e.g., a content-management system (CMS)) and paste the changes to the content piece in another tool (e.g., a print-production system (PPS)), as certain content-creation features (e.g., editing tools) may not be available on one or more of the tools employed to assemble the content.

It may be desirable to allow for improved workflow efficiencies for assembling online content and print content. At least some embodiments of systems and methods described herein eliminate and/or reduce redundancies that result when assembling content for online and print production using conventional tools and techniques. Embodiments of systems and methods described herein may, in some scenarios, provide an easy to use, intuitive, streamlined, and/or collaborative tool for producing content. One example context in which at least some of the embodiments of methods and systems described herein are particularly useful is fast-moving newsrooms.

Embodiments of systems and methods described herein may, in some scenarios, create opportunities for content producers to generate interesting and dynamic stories (referred to herein sometimes as content pieces). Because content producers may be able to create dynamic stories for publishing, content consumers may be more engaged when consuming the published content.

In at least one embodiment, links can be added, photos of various sizes can be embedded and can be arranged in various positions (e.g., left or right), and such links and photos can be sent to various content producers (e.g., members of a team).

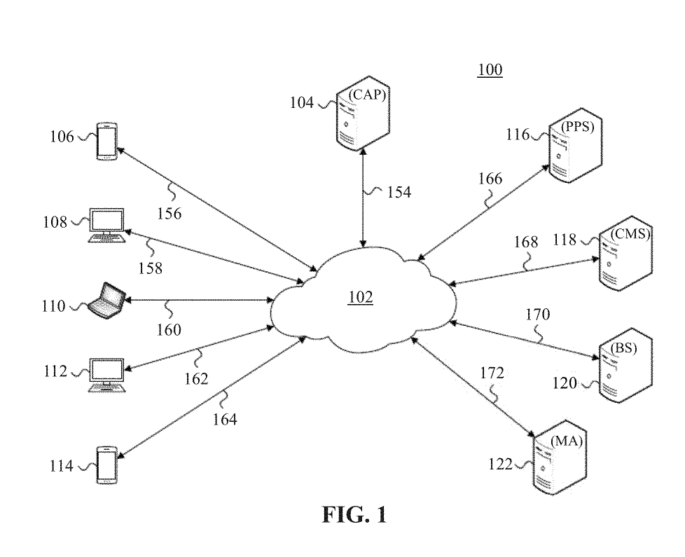

FIG. 1 depicts an example communication system, which includes an example network and an example content assembly platform, in accordance with at least one embodiment. The communication system 100 of FIG. 1 includes a network 102, a content assembly platform (CAP) 104 (which is indicated as such in FIG. 1 with a “CAP” designation), client devices 106-114, a print-production system (PPS) 116 (which is indicated as such in FIG. 1 with a “PPS” designation), a content management system (CMS) 118 (which is indicated as such in FIG. 1 with a “CMS” designation), budgeting system (BS) 120 (which is indicated as such in FIG. 1 with a “BS”), messaging application (MA) 122 (which is indicated as such in FIG. 1 with a “MA” designation) and communication links 154-172. It should be understood that the communication system 100 is presented by way of example and not limitation, as numerous other example communication systems could be present in various different scenarios. The CAP 104 is communicatively connected to the network 102 via the communication link 154. The client devices 106-114 are respectively communicatively connected to the network 102 via the communication links 156-164. The PPS 116 is communicatively connected to the network 102 via the communication link 166. The CMS 118 is communicatively connected to the network 102 via the communication link 168. The BS 120 is communicatively connected to the network 102 via the communication link 170. The MA 122 is communicatively connected to the network 102 via the communication link 172.

Any one or more of the communication links 154-172 (as well as any one or more of any of the communication links that are described in connection with any of the other figures) could, unless context dictates otherwise, take the form of or include one or more wireless-communication links, one or more wired-communication links, one or more networks, one or more access points, one or more routers, switches, bridges and/or computers, and/or one or more devices and/or connections of any type deemed suitable by those having skill in the relevant art for a given implementation. And although certain communication links are depicted in embodiments herein as wireless or wired links, it is reiterated that any one or more of the links discussed herein could be wired and/or wireless in nature.

The network 102, for example, may include a radio access network (RAN) (not shown), a packet-switched data network (PDN) (not shown), and a circuit-switched telephone network (CTN) (not shown). In such an example, the network 102 includes multiple networks. However, in various different embodiments, the network 102 may include any number of RANs, any number of PDNs, and/or any number of CTNs. Furthermore, the network 102 may be, include, be part of, be connected to, or be independent of the global network of networks commonly known as the Internet. Some entities that communicate via the network 102 may do so using Internet Protocol (IP) communication and may be identified using IP addresses.

The RAN and the PDN, for example, may be connected via a first communication link (not shown); the RAN and the CTN, for example, may be connected via a second communication link (not shown); and/or the PDN and the CTN, for example, may be connected via a third communication link (not shown). Moreover, a fourth communication link (not shown), for example, may connect the RAN—and therefore the network 102—with one or more entities external to the network 102; a fifth communication link (not shown), for example, may connect the PDN—and therefore the network 102—with one or more entities external to the network 102; and a sixth communication link (not shown), for example, may connect the CTN—and therefore the network 102—with one or more entities external to the network 102. In various different embodiments, any one or more of the first, second, third, fourth, fifth, and/or sixth communication links could be or include any one or more of the communication links 154-172 of FIG. 1. In general, then, any CCD discussed in this disclosure can communicate with any other CCD by way of any suitable communication paths that include one or more networks of any suitable types and/or one or more communication links of any suitable types.

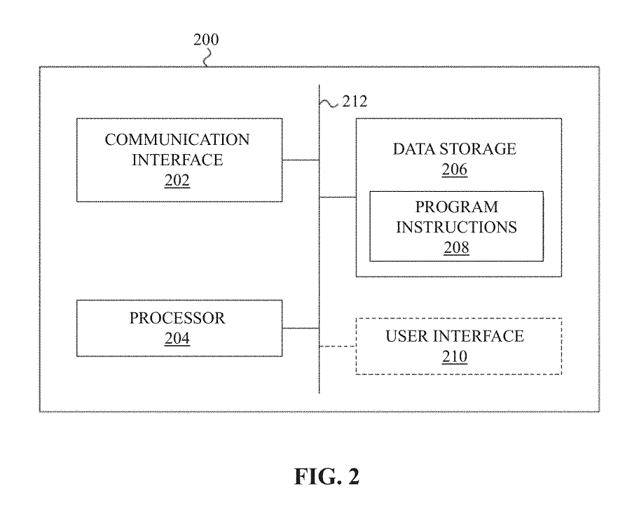

The CAP 104, each of the client devices 106-114, the PPS 116, the CMS 118, the BS 120, and the MA 122 are or at least include one or more CCDs such as the example CCD 200 that is described below in connection with FIG. 2. As such, each such device may include a respective (wireless and/or wired) communication interface, a respective processor, and respective data storage containing respective instructions executable by the respective processor for carrying out the functions described herein in connection with the respective CCD. Any one or more of those entities could take the form of or include multiple devices; as examples, one or more of the CAP 104, the PPS 116, the CMS 118, the BS 120 and/or the MA 122 could take the form of or include a system of multiple servers.

FIG. 2 depicts an example CCD, in accordance with at least one embodiment. In the depicted embodiment, the example CCD 200 includes a communication interface 202, a processor 204, data storage 206 containing program instructions 208, and an optional user interface 210, all of which are communicatively connected by a system bus 212 (or other data connection, network, or the like). Other architectures for CCDs could be used as well, as the provided and described architecture is presented herein by way of example and not limitation.

The communication interface 202 may include one or more wireless-communication interfaces (for communicating according to, e.g., LTE, Wi Fi, Bluetooth, and/or the like) and/or one or more wired-communication interfaces (for communicating according to, e.g., Ethernet, USB, and/or the like). As such, the communication interface 202 may include any necessary hardware (e.g., chipsets, antennas, Ethernet cards, etc.), any necessary firmware, and any necessary software for conducting one or more forms of communication with one or more other entities as described herein.

The processor 204 may include one or more processors of any type deemed suitable by those of skill in the relevant art, some examples including a general-purpose microprocessor and a dedicated digital signal processor (DSP).

The data storage 206 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. The data storage 206 contains program instructions 208 that are executable by the processor 204 for carrying out various functions described herein.

The optional user interface 210 may be present in CCDs that are client devices, and may or may not be present in CCDs that are servers. When present, the optional user interface 210 may include one or more input devices (a.k.a. components and/or the like) and/or one or more output devices (a.k.a. components and/or the like). With respect to input devices, the optional user interface 210 may include one or more touchscreens, keyboards, mice, trackpads, touchpads, other pointing devices, buttons, switches, knobs, microphones, and/or the like. With respect to output devices, the optional user interface 210 may include one or more displays, monitors, speakers, light emitting diodes (LEDs), and/or the like. Moreover, one or more components (e.g., an interactive touchscreen-and-display component) of the optional user interface 210 could provide both user-input and user-output functionality. And certainly other user-interface components could be used in a given context, as known to those of skill in the art.

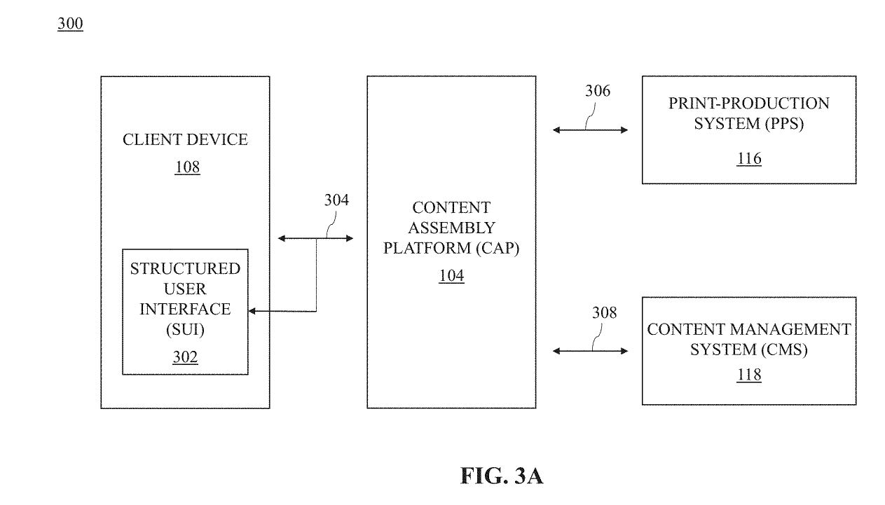

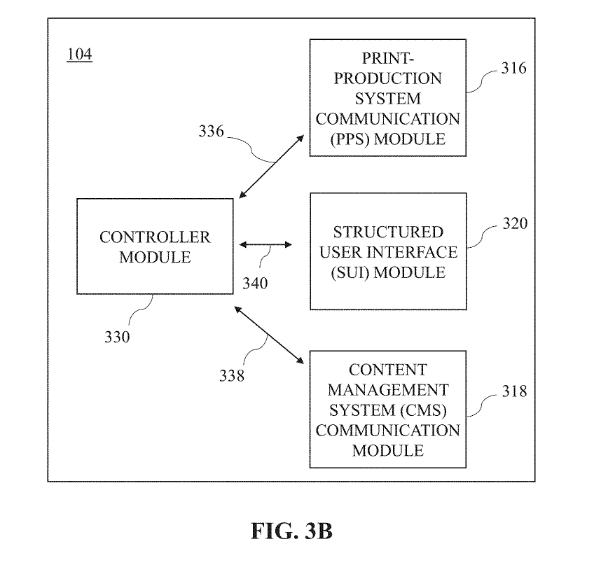

FIG. 3A depicts an example simplified arrangement of the example communication system of FIG. 1 and explicitly depicts an example structured user interface (SUI), in accordance with at least one embodiment. For clarity and simplicity of explanation, the network 102, the client devices 106 and 110-114, and the communication links 154-172 are not depicted in FIG. 3A. In the depicted embodiment, the example simplified arrangement 300 includes the CAP 104 of FIG. 1, the PPS 116 of FIG. 1, and the CMS of 118 of FIG. 1 and further includes the client device 108 of FIG. 1, on which (in this example) the SUI 302 is presented. Each of the CAP 104, the client device 108, the PPS 116, and the CMS 118 are described above in connection with FIG. 1. The SUI 302 may be presented at various times on or via one or more of the client devices 106-114. In the depicted embodiment, the SUI 302 is presented, via the CAP 104, on the client device 108.

In the depicted embodiment, the CAP 104 is communicatively connected to the client device 108, the PPS 116, and the CMS 118 via communication links 304, 306, and 308, respectively. As depicted in FIG. 3A at 304, the CAP 104 may provide output to and/or receive input from the client device 108, and/or the client device 108 may receive output from and/or provide input to the CAP 104. The CAP 104 may receive input from the client device 108 and/or may provide output to the client device 108, as shown in FIG. 3A at 304. In at least one embodiment, the CAP 104 receives, at least, content-assembly-related input from the client device 108 and provides, at least, content-assembly-related output to the client device 108. In at least one such embodiment, the content-assembly-related output provided by the CAP 104 may be provided for presenting of the SUI 302 on the client device 108. In such at least one embodiment, the client device 108 provides the content-assembly-related input to the CAP 104 based on, at least in part, data entered via the SUI 302 by a content producer associated with the client device 108. For example, while being presented with the SUI 302 via the client device 108, the content producer may enter data via the SUI 302, and in response to such data being entered, the client device 108 may provide, to the CAP 104, content-assembly-related input based on the entered data. In at least one embodiment, the SUI 302 interacts with the CMS 118 via a CMS-agnostic application programming interface (API). In at least one embodiment, the SUI 302 is configured to receive identifiers of audio and/or visual content items for embedding in the content piece.

The CAP 104 may receive input from and/or provide output to the PPS 116, as shown in FIG. 3A at 306. In at least one embodiment, the CAP 104 receives, at least, print-publication-related input from the PPS 116 and provides, at least, print-publication-related output to the PPS 116. In such an embodiment, the print-publication-related output provided by the CAP 104 may be provided in response to receiving an instruction to publish a content piece to the PPS 116. In at least one of such an embodiment(s), the print-production-related output provided by the CAP 104 is in a print-production-system readable format.

The CAP 104 may receive input from and/or provide output to CMS 118, as shown in FIG. 3A at 308. In at least one embodiment, the CAP 104 receives, at least, online-publication-related input from the CMS 118 and provides, at least, online-publication-related output to the CMS 118. In at least one embodiment, the online-publication-related output provided by the CAP 104 may be provided for storing in the CMS 118. In at least one of such an embodiment(s), the online-publication-related output provided by the CAP 104 for storing in the CMS 118 may be provided for online publication according to a set of predetermined content-display rules. In at least one embodiment, the CAP 104 sits on top of a CMS database of and/or associated with the CMS 118.

In the present disclosure, various elements of one or more of the described embodiments are referred to as “modules” that carry out (i.e., perform, execute, and the like) various functions described herein. As the term “module” is used herein, each described module includes hardware (e.g., one or more processors, microprocessors, microcontrollers, microchips, application-specific integrated circuits (ASICs), field programmable gate arrays (FPGAs), memory devices, and/or one or more of any other type or types of devices and/or components deemed suitable by those of skill in the relevant art in a given context and/or for a given implementation). Each described module also includes instructions executable for carrying out the one or more functions described as being carried out by the particular module, where those instructions could take the form of or at least include hardware (i.e., hardwired) instructions, firmware instructions, software instructions, and/or the like, stored in any non-transitory computer-readable medium deemed suitable by those of skill in the relevant art.

FIG. 3B depicts an example architecture of the example CAP 104 of FIG. 1, in accordance with at least one embodiment. In the depicted embodiment, the CAP 104 includes a controller module 330, a PPS communication module 316, a CMS communication module 318, and a SUI module 320. As depicted in FIG. 3B, the controller module 330 is communicatively connected to the PPS communication module 316, the CMS communication module 318, and the SUI module 320 via communication links 336, 338, and 340, respectively.

In at least one embodiment, the controller module 330, at least in part, controls and/or assists in control of communications between: (a) the CAP 104 and the client device 108, (b) the CAP 104 and the PPS 116, and (c) the CAP 104 and the CMS 118. For example, the controller module 330 may control and/or assist in control of the CAP 104 receiving content-assembly-related input from the client device 108 and/or providing content-assembly-related output to the client device 108. As another example, the controller module 330 may control and/or assist in control of the CAP 104 receiving print-publication-related input from the PPS 116 and/or providing print-publication-related output to the PPS 116. As a further example, the controller module 330 may control and/or assist in control of the CAP 104 receiving online-publication-related input from the CMS 118 and/or providing online-publication-related output to the CMS 118.

In at least one embodiment, the controller module 330 is capable of keeping track of one or more content producers who are currently editing or otherwise modifying a content piece so that when another content producer opens a story that is currently being worked on by the one or more content producers, those content producers and/or the other content producer is presented with a cue (e.g., a visual cue) that there is a potential conflict corresponding to that content piece.

In at least one embodiment, the controller module 330 is configured to receive input from one or more of the PPS communication module 316, the CMS communication module 318, and/or the SUI module 320 and/is configured to provide output to one or more of the PPS communication module 316, the CMS communication module 318, and/or the SUI module 320. The controller module 330 may be configured to receive input from the client device 108 and/or the SUI 302 via the SUI communication module 320 and/or may be configured to provide output based on such input to one or more other modules (e.g., the PPS communication module 316 and/or the CMS communication module 318) for example, for transmission to one or more devices, servers, etc. (e.g., the PPS 116 and/or the CMS 118). The controller module 330 may be configured to receive input from the PPS 116 via the PPS communication module 316 and/or may be configured to provide output based on such input to one or more other modules (e.g., the SUI module 320 and/or the CMS communication module 318), for example, for transmission to one or more devices, servers, etc. (e.g., the client device 108 and/or the CMS 118). The controller module 330 may be configured to receive input from the CMS 118 via the CMS communication module 318 and/or may be configured to provide output based on such input to one or more other modules (e.g., the PPS communication module 316 and/or the SUI module 320), for example, for transmission to one or more devices, servers, etc. (e.g., the PPS 116 and/or the client device 108).

In at least one embodiment, the SUI module 320 is configured to present a structured user interface for structured receipt of authored content. For example, the SUI module 320 may be configured to present the SUI 302, which may be presented on client device 108 and/or one or more of client devices 106, 110-114. The authored content may be, for example, provided by one or more content producers. In at least one embodiment, the SUI module 320 is configured to receive content for a content piece via a structured user interface. For example, the SUI module 320 may be configured to receive content for a content piece via the SUI 302. In at least one embodiment, the SUI module 320 is configured to present received content via a structured user interface according to a set of predetermined content-display rules. For example, the SUI module 320 may be configured in such a way that after receiving content for a content piece via the SUI 302, the SUI module 320 presents the received content for the content piece via the SUI 302 according to a set of predetermined content-display rules. In at least one embodiment, the SUI module 320 is configured to provide received content to a controller module. For example, the SUI module 320 may be configured to provide received content (e.g., received via the SUI 302) to the controller module 330. The SUI module 320 may, for example, be further configured to receive a print-production-sever command via the structured user interface 302, and/or the PPS communication module 316 may, for example, be further configured to responsively transmit a print-production-severed instruction to the PPS 116.

In at least one embodiment, the controller module 330 is configured to receive content from the SUI module 320 and provide the received content to the CMS communication module 318 and to the PPS communication module 316.

In at least one embodiment, the CMS communication module 318 is configured to receive received content from the controller module 330. For example, the received content that the CMS communication module 318 may be configured to receive may be or include content for a content piece that the SUI module 320 is configured to receive via the SUI 302. In at least one embodiment, the CMS communication module 318 is configured to transmit received content to a CMS for online publication according to predetermined content-display rules that are also the predetermined content-display rules according to which the SUI module 320 is configured to present content received via the SUI 302.

In at least one embodiment, the PPS communication module 316 is configured to receive an instruction to publish a content piece to a print-production system. For example, the PPS communication module 316 may be configured to receive an instruction from a controller module of a content-assembly platform (e.g., the controller module 320) and/or may be configured to receive an instruction from a print production system (e.g., the PPS 116). In at least one embodiment, the PPS communication module 316 is configured to receive received content from a controller module in response to receiving an instruction to publish a content piece to a print-production system. In at least one embodiment, the PPS communication module 316 is configured to package content in a print-production-system-readable format. For example, the PPS communication module 316 may be configured to package, in response to receiving an instruction to publish a content piece (e.g., a content piece including, at least in part, content received via a structured user interface) to a print production system (e.g., the PPS 116), received content provided by the controller module 330, the received content being packaged in a print-production-system-readable format (e.g., a format readable by the PPS 116). The print-production-system-readable format, may be, an XML format. Of course the print-production-system-readable format could be numerous other example print-production-system-readable formats as is known to those of ordinary skill in the art.

In at least one embodiment, the PPS communication module 316 is configured to transmit packaged content to a print production system. For example, the PPS communication module 316 may be configured to transmit packaged content to the PPS 116 that may be packaged (e.g., by the PPS communication module 316) in a format readable by PPS 116. In at least one embodiment, the PPS communication module 316 is further configured to, multiple iterative times, (a) package the received content in the print-production-system-readable format and (b) transmit the packaged content to the print-production system, to provide rolling updates of the content piece to the print-production system. Each rolling update may, for example, comprise a complete copy of the updated content piece. In at least one embodiment, the PPS communication module 316 is further configured to use Simple Object Access Protocol (SOAP) communication to transmit the packaged content to the PPS 116. In at least one embodiment, the SUI module 320 is further configured to receive a trim indication for the content piece via the SUI 302, and the PPS communication module 316 is further configured to package the received content in the print-production-system readable format in such a way as to include the received trim indication in the packaged content.

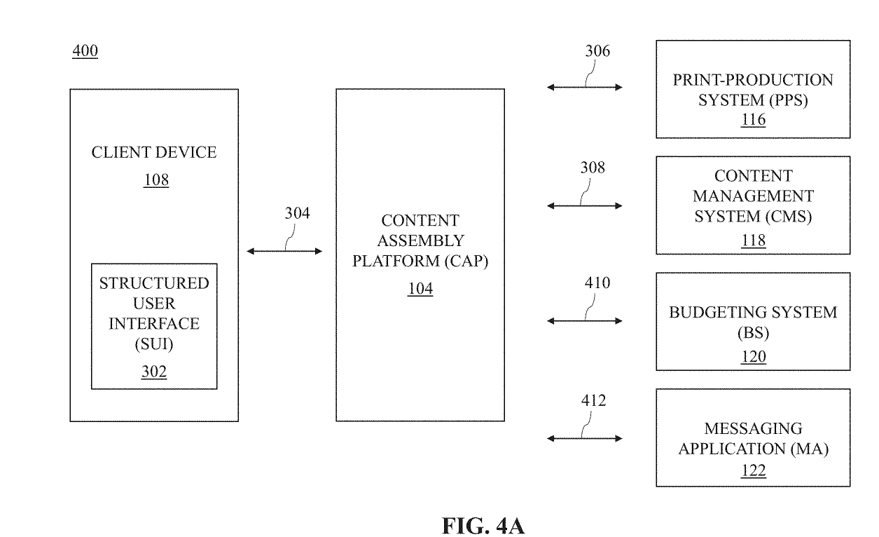

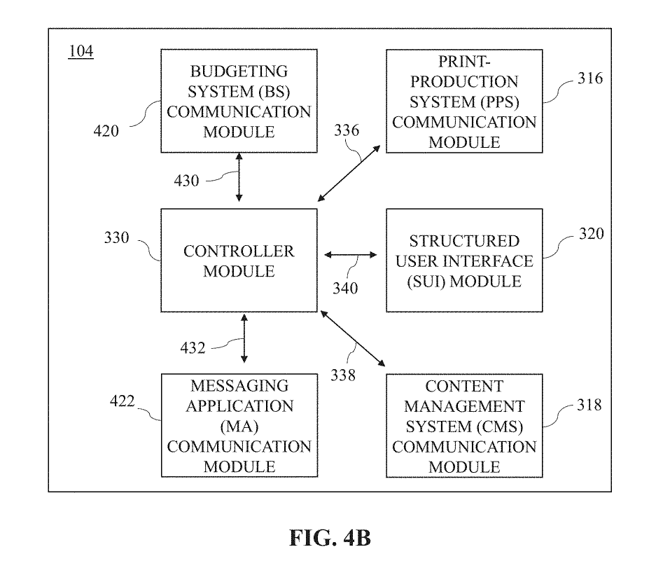

FIG. 4A depicts the example simplified arrangement of the example communication system 300 of FIG. 3A. and additionally includes the example BS 120 of FIG. 1 and the example MA 122 of FIG. 1, in accordance with at least one embodiment. In at least one embodiment, the CAP 104 of FIG. 4A is communicatively connected to the client device 108, the PPS 116, and the CMS 118 in the same manner as described above in connection with FIG. 3A. In the depicted embodiment, the CAP 104 is additionally communicatively connected to the BS 120 and to the MA 122. In at least one embodiment, the SUI 302 is integrated with the BS 120.

The CAP 104 may receive input from and/or provide output to BS 120, as shown in FIG. 4A at 410. In at least one embodiment, the CAP 104 receives content-budgeting-related input from the BS 120 and provides content-budgeting-related output to the BS 120. The CAP 104 and the BS 120 may, for example, be integrated via a REST API call (from the CAP 104 to the BS 120) with a JSON payload.

The CAP 104 may receive input from and/or provide output to MA 122, as shown in FIG. 4A at 412. In at least one embodiment, the CAP 104 receives messaging-related input from the MA 122 and provides messaging-related output to the MA 122.

The SUI 302 may be integrated with the MA 122 via an MA-supplied API. For example, the MA 122 may be a commercially available messaging application such as, for example, the Slack® messaging application and/or the HipChat® messaging application, to name two. Of course, the SUI 302 may be integrated with numerous other messaging applications (e.g., publicly/commercially available MAs and/or propriety MAs) in various other implementations. In one or more embodiments including an SUI that is integrated with the Slack® messaging application, such integration may be accomplished with a slackbot.

FIG. 4B depicts another exemplary architecture of the example CAP of FIG. 1, in accordance with at least one embodiment. In the depicted embodiment, the CAP 104 includes from FIG. 3B the controller module 330, the PPS communication module 316, the CMS communication module 318, and the SUI module 320, and this embodiment of the CAP 104 additionally includes a budgeting system (BS) communication module 420 and a messaging application (MA) communication module 422. The controller module 330 may be communicatively connected with the PPS communication module 316, the CMS communication module 318, and/or the SUI module 320 in the same manner as described above in connection with FIG. 3A. In the depicted embodiment, the CMS communication module 318 is communicatively connected to the BS communication module 420 at 430 and/or is communicatively connected to the MA communication module 422 at 432.

The SUI module 320 may be, for example, configured to receive a workflow command via the SUI 302. In such an example, the SUI module 320 may responsively provide the received workflow command to the MA communication module 422, and/or the MA communication module 422 may be configured to responsively transmit an associated workflow message via the integrated messaging application. Additionally, in such an example where the MA communication module 422 is configured to transmit the associated workflow message via the integrated messaging application, the MA communication module 422 may be configured to transmit the associated workflow message via a content-appropriate channel provided by the integrated messaging application. Alternative or additionally, in such an example, the MA communication module 422 may be configured to obtain an integrated-messaging-application-generated token for user authentication (e.g., with respect to the integrated messaging application) and/or may be configured to authenticate a user with the integrated messaging application one or more times using the obtained token.

Before proceeding with the balance of this detailed description, a particular linguistic point is worth making. The following two different terms are used in this disclosure: (i) structured user interface (SUI) and (ii) user interface (or optional user interface). The latter, user interface (or optional user interface), refers to hardware components, software drivers, and the like that are part of and/or installed on a given client-side computing device, consistent with the description of the optional user interface 210 above. Thus, a given user interface (or optional user interface) is a permanent or at least semi-permanent part of its respective CCD. The former, SUI, refers in this disclosure to the executing codebase and corresponding presented visual elements that are particular to embodiments of the present systems and methods.

Some characteristics of a representative embodiment are that (i) the codebase is a downloaded JavaScript codebase and (ii) the SUI is presented via a web browser (that itself would naturally be presented via the user interface (e.g., the display monitor) of the CDD that has downloaded and is executing the JavaScript codebase). Of course these are only examples, but they serve to illustrate the distinction between SUI and user interface (or optional user interface) as those terms are used herein. In another example, a CCD is a tablet: the user interface (or optional user interface) includes the physical touchscreen of that tablet; the SUI of the present methods and systems may be presented in a web browser or an installed application that is executing on the CCD (i.e., tablet). And certainly other examples could be presented here as well.

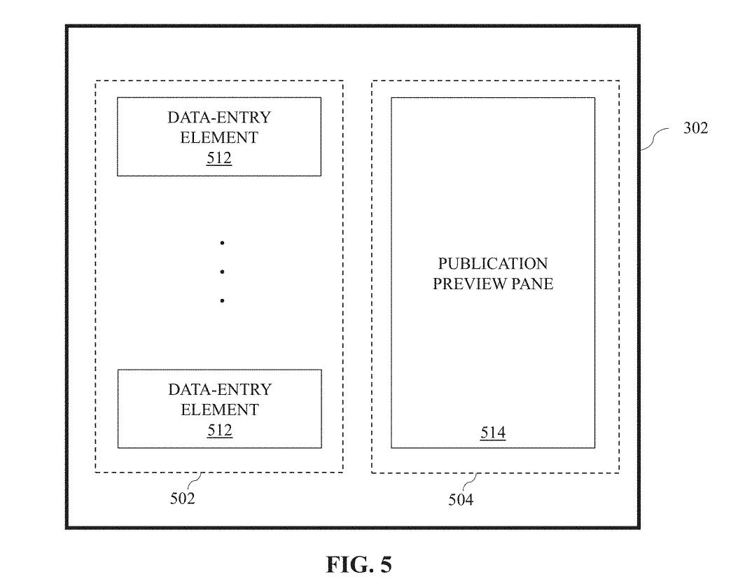

FIG. 5 depicts the example SUI 302 of FIG. 3A (and/or FIG. 3B), in accordance with at least one embodiment. One or more content producers may view one or more screens associated with the SUI 302 to, at least in part, assemble a content piece and/or content of a content piece. The depicted embodiment of the SUI 302 includes a first region 502 and a second region 504. In at least one embodiment, the first region 502 and the second region 504 are separate regions of the SUI 302.

The first region 502 is a portion of the SUI 302 that includes one or more data entry elements 512. For example, the portion of the SUI 302 that presents the one or more data entry elements 512 may be delineated as part or all of the first region 502. In at least one embodiment, the first region 502 includes the one or more data entry elements 512 for respectively receiving different aspects of a content piece. For example, one or more data-entry elements 512 may respectively receive data representing and/or related to one or more aspects of a content piece. In at least one embodiment, one or more data-entry elements respectively receive data for controlling and/or modifying presentation of the SUI 302. For example, the one or data-entry elements 512 may respectively receive input (e.g., from a content producer) that modifies presentation of one or more data entry elements 512, the first region 502, the second region 504, and/or any other region of the SUI 302.

The second region 504 is another portion of the SUI 302 and includes a publication preview pane 514. For example, the other portion of the SUI 302 that presents the publication preview pane 514 may be delineated as part or all of the second region 504. In at least one embodiment, content based on data received via the one or more data entry elements 512 is uneditably presented in the second region 504 according to predetermined content-display rules. Characteristics (e.g., number, position, size, shape, etc.) of the first region 502, the second region 504, the data entry elements 512 and the publication preview pane 514, with respect to each other and with respect to the SUI 302 are presented herein by way of example and not limitation. Of course, in various different scenarios, numerous additional and/or alternative example SUIs may be present and may include numerous other regions, data entry elements, and/or publication preview panes.

In at least one embodiment, a content producer enters data into at least one of the one or more data entry elements 512 of the first region 502 and, responsive to such entering of data, content is presented in the publication preview pane 514 of the second region 504. In at least one embodiment, as the content producer enters data into at least one of the one or more of the data entry elements 512, the content presented by the publication preview pane 514 is dynamically updated based on the newly entered data. In at least one embodiment, the publication preview pane 414 presents content according to a set of predetermined content-display rules that are the same as or substantially similar to a set of predetermined content-display rules for publishing online content. For example, the publication preview pane 514 may present content according to a set of predetermined content display rules that are the same as or substantially similar to a predetermined set of content display rules for publishing online content via one or more content-management systems (e.g., the CMS 118). In at least one embodiment, based on a predetermined set of content-display rules, the publication preview pane 514 presents content in a what-you-see-is-what-you-get (WYSIWYG) manner. In at least one embodiment, the SUI 302 may be configured to receive data for causing generation of responsive HTML charts, inline images and quotes, photo layouts and section headers. The one or more data entry elements 512, individually or collectively, may take a variety of forms, may serve a variety of purposes, and/or may function in a variety of manners. For example, the one or more data entry elements 512 may be or include a data entry-field and/or a data-entry widget.

In at least one embodiment, the publication preview pane 514 presents content according to a set of predetermined content-display rules that are based on market configuration rules. The market configuration rules may, for example, be content-producer specific. The publication preview pane 514 may, for example, present content differently depending on the market configuration rules associated with a given content producer. For example, if a first content producer (e.g., a writer for the LA Times) is providing data to the data entry elements 512, then content may be presented in the publication preview pane 514 according to first content-display rules associated with the first content producer. As another example, if a second content producer (e.g., a writer for the Chicago Tribune) is providing data to the data entry elements 512, then content may be presented in the publication preview pane 514 according to second content-display rules associated with the second content producer. The market configuration rules may also allow one or more content producers to have content-producer specific slugging conventions. The market configuration rules may be externalized (e.g., are not part of the application code) and/or may be managed via an administrative interface. The administrative interface may be available only to a subset of a plurality of content producers (e.g., to which the SUI 302 is available).

It is noted that, in various places in the balance of this detailed description, various example screenshots are depicted and described. These are examples of screenshots that could be presented via the example CAP 104 of the present systems and methods. In at least one embodiment, these screenshots (as part of the structured user interface of the present systems and methods) are presented via a web browser that is being executed by at least one of the client devices 106-114. Thus, in such at least one embodiment, the rendered structured-user-interface elements, text, and so on would correspond with HTML code that is provided to and then displayed by the web browser (e.g., Microsoft Edge®, Microsoft Internet Explorer®, Mozilla Firefox®, Apple Safari®, Google Chrome®, and/or the like). This HTML code could be generated at least in part by runtime execution of JavaScript code. In at least one embodiment, a static-URL implementation is used across screenshots, such that the displayed URL doesn't change, though asynchronous (e.g., AJAX) messaging can be going on in the background, resulting in changes to the displayed information. Such aspects of modern web programming are within the skill of those in the art, and are thus not exhaustively explained herein.

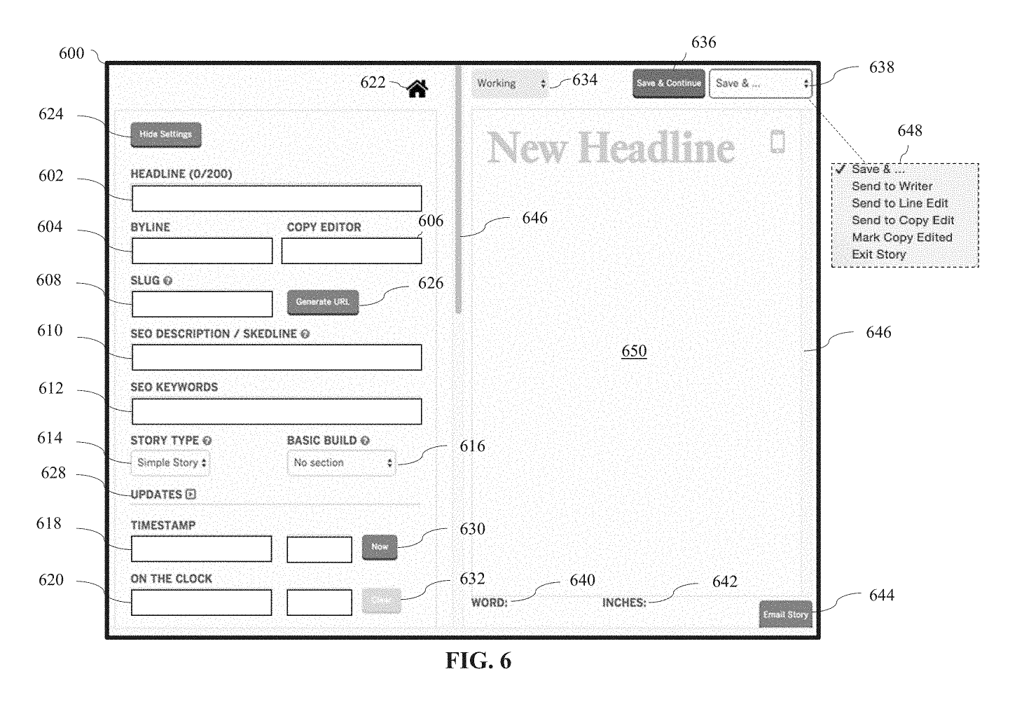

FIG. 6 depicts a first example screen of the SUI 302 presented via the CAP 104 of FIG. 1, in accordance with at least one embodiment. This screenshot, as is the case with all example screenshots presented herein by way of example, could be a webpage viewable via a web browser, a user interface presented by an app, and/or one or more other options deemed suitable by those having skill in the art for a given implementation.

The example screenshot 600 of FIG. 6 may be presented, for example, to a content producer after first passing through one or more conventional HTML screens directing the content producer through activities such as logging in to and/or creating an account. The screenshot 600 may be presented, for example, to a content producer in response to selection of and/or data entry into (e.g., by the content producer) an element associated with the screenshot 600. For example, the screenshot 600 may be presented in response to a content producer selecting a new-blank-story element presented on a prior screen, which is described in more detail below. As another example, the screenshot 600 may be presented in response to a content producer selecting a recent-collection element associated with the screenshot 600 and presented on a prior screen, which is described in more detail below.

The screenshot 600 generally includes a number of elements, which are depicted in FIG. 6 as a number of data-entry elements and a publication preview pane. One or more of the example data-entry elements depicted in FIG. 6 may be, may form, and/or may be part of the first region 502 of FIG. 5 and/or may be part of the second region 504 of FIG. 5. For example, the data entry elements having reference numerals 602-632 may form at least part of the first region 502 and/or the data entry elements having reference numerals 634-644 may form at least part of the second region 504. In such an example, the publication preview pane 650 may also form at least part of the second region 504.

The data entry elements depicted in the screenshot 600 of FIG. 6 include a headline field 602, a byline field 604, a copy-editor field 606, a slug field 608, an SEO (search engine optimization) description/skedline field 610, a SEO-keywords field 612, a story-type widget 614, a basic-build widget 616, a timestamp field 618, an on-the-clock field 620, a home-navigation button 622, a hide-settings button 624, a generate-URL (uniform resource locator) button 626, an updates button 628, a now button 630, and a clear button 632. And certainly, numerous other example data-entry elements (and their associated functions) could be depicted and described here for any given implementation by those having ordinary skill in the art, as those shown and described here are provided by way of example and not limitation. For example, example buttons, data fields, widgets, and/or other (structured) user-interface elements (e.g., dropdown elements) could be depicted and described here, as those shown and described are provided by way of example and not limitation.

In at least one embodiment, the headline field 602, the byline field 604, the copy-editor field 606, the slug field 608, the SEO-description/skedline field 610, and/or the SEO-keywords field 612 are free-text fields into which the content producer can enter a free-text narrative.

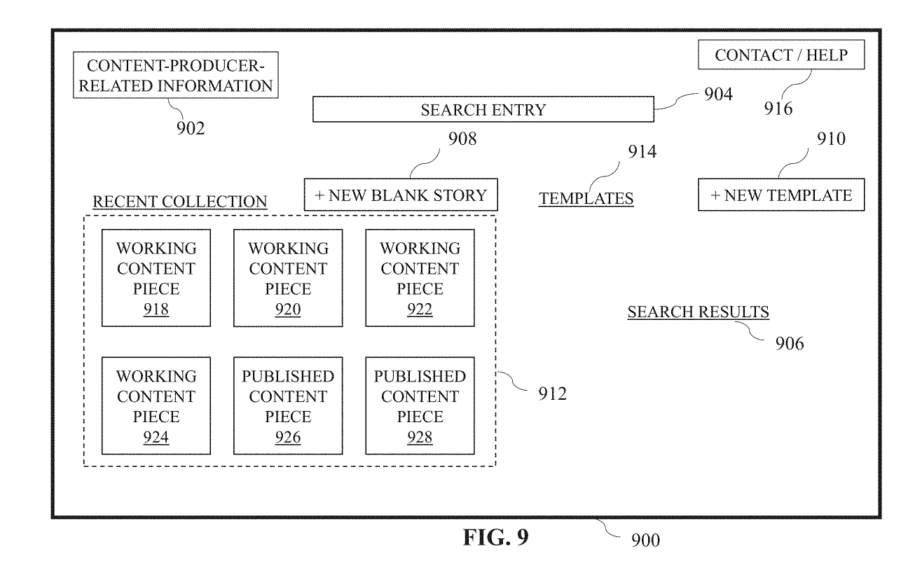

In the depicted embodiment, all the selectable and/or fillable data-entry elements included in the screenshot 600 are blank (e.g., unfilled and/or unselected) and/or are populated with default values. In at least one embodiment, at least one of the selectable and/or fillable data-entry elements that are unfilled and/or unselected are populated with respective default values. For example, as shown in the depicted embodiment, the headline field 602 of FIG. 6 may be unfilled, as no text is presented in the headline field 602; the basic-build widget 616 of FIG. 6 may be populated with a default value (e.g., “No section”); and the story-type widget of FIG. 6 may be populated with a default value (e.g., “Simple Story”). In at least one embodiment, the screenshot 600 is presented with such blank and/or default-value-populated data-entry elements in response to the content producer choosing to create a new blank story, which is described in greater detail below in connection with FIG. 9.

In at least one embodiment, the SUI 302 responds to any (or periodically detected, or the like) text changes in the headline field 602, the byline field 604, the copy-editor field 606, the slug field 608, the SEO-description/skedline field 610, and/or the SEO-keywords field 612 by locally saving the current text in the respective field(s) and marking (e.g., in a manner not necessarily apparent to the content producer) the respective field(s) as being in a “dirty” state (i.e., containing different input than what (if anything) had previously been saved). As is known in the arts of web programming, memory (e.g., cache) design and management, and/or the like, elements are often initialized to a “clean” state, marked “dirty” upon a substantive change being detected, and then reset to clean after that substantive change has been saved to an upstream (and typically relatively more stable) entity such as a remote server, a hard drive, and/or the like. In various different embodiments, the SUI 302 may include data-entry element specific indications of content-producer input having been locally and/or remotely stored; moreover, overall indications of whether all then-entered content-producer input has been locally and/or remotely stored may be provided as well. And certainly other example implementations could be listed here.

The headline field 602 may be a field that allows a content producer to enter in text corresponding to a headline of a content piece associated with the screenshot 600. In at least one embodiment, the headline field 602 is a character-limited field, which prohibits entry of text beyond a threshold number of characters. For example, the headline field 602 may be limited to a maximum of two hundred (200) characters and/or may be limited to a minimum of five (5) characters. As depicted in FIG. 6, the headline field 602 is limited to two-hundred (200) characters, and as a result, the headline of the content piece associated with screenshot 600 (in this example embodiment) may include no more than two hundred (200) characters. The character limit of two-hundred (200) characters is only for illustrative purposes and is in no way intended to be limiting. Of course, in the one or more embodiments where the headline field 602 is a character-limited field, the headline field 602 may be limited to any suitable character limit. As another example, the headline field 602 may additionally or alternatively be limited to any number of words. Of course, the headline field 602 could be limited with respect to entry of data in numerous other ways known to one of ordinary skill in the art.

Such a limit on the number of characters, words, etc. permitted to be entered in to the headline field 602 may be, for example, based on stylistic and/or practical considerations of producing online and/or print content and/or may be based on any number of other considerations. In at least one embodiment, the threshold number of characters and/or words permitted in the headline field 602 is adjustable by one or more content producers, one or more administrators, and/or one or more other individuals. And certainly other example implementations could be listed here.

The byline field 604 may be a field that allows a content producer to enter in text corresponding to a byline of a content piece associated with the screenshot 600. The copy-editor field 606 may be a field that allows a content producer to enter in text corresponding to a copy editor of a content piece associated with the screenshot 600. In at least one embodiment, the byline field 604 and/or the copy-editor field 606 are automatically populated based on content-producer related data. For example, the byline field 604 and/or the copy-editor field 606 may be automatically populated based on content-producer related data (e.g., content-producer account-login credentials) of a currently logged-in content producer. For example, the currently logged-in content producer may have her name and/or a copy editor's name (e.g., a name of a copy editor who typically copy edits the currently logged-in content producer's work) stored as part of an account associated with the content producer's log-in credentials. The content producer's name and/or the content producer's copy editor's name may be retrieved (e.g., from one or more databases storing content-producer related data) to populate the byline field 604 and/or the copy-editor field 606. And certainly other example implementations could be listed here.

The slug field 608 may be a field that allows a content producer to enter in text corresponding to a slug of a content piece associated with the screenshot 600. One or more alphanumerics included in the slug field 608 may form a unique identifier for a particular content piece, and the unique identifier may be referred to as a slug. In at least one embodiment, a content piece associated with the screenshot 600 is uniquely identified within the CAP 104 by a unique identifier. For example, one or more slugs associated with (e.g., uniquely identifying) one or more respective content pieces may be stored in one or more databases and/or each of the one or more respective slugs may be mapped to the respective content piece that the slug identifies. The one or more slugs may be searchable and/or retrievable. As described in more detail below, such one or more slugs may be used as search entries to retrieve the respective content piece to which the slug is mapped and/or is otherwise associated.

In at least one embodiment, the one or more slugs conform to one or more workflow-shaping conventions. The one or more slugs may be, for example, generated based on the one or more workflow-shaping conventions. In at least one embodiment, a particular one of the one or more workflow-shaping conventions employed for generating a particular slug or group of slugs is determined based on content-producer-related information corresponding to a particular content producer of a set of one or more content producers. In at least one embodiment, a first subset of the one or more workflow-shaping conventions is employed by a first subset of the set of one or more content producers and a second subset of the one or more workflow-shaping conventions is employed by a second subset of the set of one or more content producers. In such at least one embodiments, the first subset of the one or more workflow-shaping conventions is different, at least in part, than the second subset of the one or more workflow-shaping conventions. For example, based on a first workflow-shaping convention employed by a first content producer, a first slug may include first-slug characteristic data which may identify a first given content piece and/or one or more elements of the first given content piece, and based on a second workflow-shaping convention employed by a second content producer, a second slug generated for a second given content piece may include second-slug characteristic data which may identify a second given content piece and/or one or more elements of the second given content piece.

In at least one embodiment, the generate-URL button 626 is selectable to generate a uniform resource locator (URL) that is associated with the slug present in the slug field 608 when the generate-URL button 626 is selected. The generated URL may then be shared with other content producers, for example, for easy access to the content piece identified by the slug. And certainly other example implementations could be listed here.

In at least one embodiment, SEO-description/skedline field 610 and/or SEO-keywords field 612 corresponds to metadata included as part of a webpage corresponding to the associated published content piece (which can be used there by search indexers to classify content) as text shown in a social media post (e.g., Facebook® post) when the associated published content piece is shared via a social media site, and/or as part of a “Skedline” (e.g., a collection of content-piece metadata) in the budgeting system (e.g., the commercially available budgeting system Desk-Net®).

In at least one embodiment, story-type widget 614 is selectable to modify presentation of the SUI 302. Modifying presentation of the SUI 302 may include, for example, changing, adjusting, removing, adding, etc., display and/or function of one or more elements and/or one or more regions of the SUI 302. The story-type widget 614 may be selectable as one or more values to respectively modify presentation of the SUI 302, for example, to one or more content producers viewing the screenshot 600. Each of the selectable values may be selectable to modify presentation of the SUI 302 in one or more respective manners that may be, for example, unique to the respective values. For example, story-type widget 614 may be selected as a first value, which may cause presentation of the SUI 302 in a first manner, and/or story-type widget 614 may be selected as a second value, which may cause presentation of the SUI 302 in a second manner different, at least in part, than the first manner. The one more selectable values (for which the story-type widget 614 may be selected) may modify presentation of the SUI 302, for example, in a corresponding manner configured via the CMS 118. The story-type widget 614 may have selectable values of, for example, “Simple Story”, “HTML Story”, “Big Story”, among numerous other values.

As depicted in the screenshot 600, the story-type widget 614 is selected as a value of “Simple Story” and depicts an example of presentation of the SUI 302 with such a selected value. In at least one embodiment, selecting the story-type widget 614 as a first value (e.g., “Simple Story”) may cause presentation of content in the publication preview pane 650 to be based on an arrangement of one or more widgets in the SUI 302. In at least one embodiment, the basic-build widget 616 is also selectable. Selection of a value of the story-type widget 614 in conjunction with selection of a value of the basic-build widget 616 (if available) may, for example, affect how a content producer creates a content piece, how the SUI 302 is presented to the content producer, how the content producer enters data into one or more elements of the SUI 302, how a content producer assembles content for a content piece, and/or how and what build-content is bundled with (authored) content. For example, selecting the story-type widget 614 as the first value (e.g., “Simple Story”) may cause presentation of content in the publication preview pane 650 to be based on an arrangement of one or more widgets in a widget manager pane, which is described in more detail below.

However, selecting the story type widget 614 as a second value (e.g., “HTML Story”) may allow for creation of content for a content piece by one or more content producers entering code. For example, selecting the second value (e.g., “HTML Story”) may allow (and/or may require) content producers to create content for a content piece by explicitly entering code, such as for example, HTML, in to one or more data-entry elements. In such an example, selecting the second value (e.g., “HTML Story”) may modify presentation of the SUI 302, for example, by not presenting the basic-build widget 616. Such example selection values of the story-type widget 614 may allow for increased flexibility with respect to creating content for a content piece and/or assembling content of a content piece. For example, content producers may have the flexibility to create and/or assemble content explicitly in HTML and/or to create and/or assemble content without entering HTML code (and/or without having to know how to code in HTML). In at least one embodiment, selecting the second value (e.g., “HTML Story”) does not allow the content producer to change website navigation HTML code and/or other predetermined HTML code.

Selecting a third value (e.g., “Big Story”) may modify presentation of the SUI 302, for example, in a manner similar to selecting the second value, except that arrangement of some content is predetermined and/or uneditable. For example, selection of the third value (e.g., “Big Story”) may cause an image (and/or other media/multi-media) to be positioned in a certain uneditable location of a content piece (e.g., at the top of the content piece, above, adjacent to or below the headline, etc.) but may allow content producers to otherwise create content for a content piece by explicitly entering code, as described in connection with the second value. As such, the third value may correspond to a content piece coded to have an image positioned in an uneditable location.

In at least one embodiment, the basic build-widget 616 may be selectable to bundle one or more consumer-facing modules with at least some content of a content piece for assembly and/or publication of the content piece. The one or more consumer-facing modules may be or include, for example, pre-determined content and/or pre-determined content-layout elements. For example, advertisement(s) (e.g., banner advertisements), navigation element(s), newsletter signup widget(s), upcoming- and/or previous-event list(s) and/or link(s), recent and/or popular content piece list(s) and/or link(s), content-consumer comment widget(s), various other links, widgets, images, videos, text, audio, and/or the like. The basic build-widget 616 may, for example, be selectable to cause presentation of one or more build options (e.g., in a drop-down menu). The one or more selectable build options that may be presented may be associated with one or more consumer-facing modules.

Selecting a build option of the one or more build options may cause the one or more respective consumer-facing modules associated with the selected build option to be bundled with at least some content of the content piece being assembled for publication. In at least one embodiment, one or more consumer facing modules that correspond to a build are automatically packaged into the presentation of the content piece being edited. For example, selecting a “sports build” as a basic build option may automatically cause a link to a schedule of a local team, links to recaps of games played by the local team, a link to a roster of the local, etc. to be published with and/or as part of the content piece being created.

The timestamp field 618 may correspond to the date and/or the time that is displayed when the story is published. The on-the-clock field 620 may correspond to the date and/or the time that the story will be published, which may be referred to as the date and/or the time that the story goes “live” (e.g., becomes accessible to one or more content consumers). And certainly other example implementations could be listed here.

In the depicted embodiment, the timestamp field 618 and the on-the-clock field 620 each include separate date and time fields. However, in at least one embodiment, the timestamp field 618 and/or the on-the-clock field 620 are a single field. The timestamp field 618, the on-the-clock field 620, and any other field described herein, unless context dictates otherwise, may include any number of fields (or sub-fields).

In at least one embodiment, the now button 630 is linked to the timestamp field 618 and/or the on-the-clock field 620 in such a way that selecting the now button 630 populates the timestamp field 618 and/or the on-the-clock field 620 with the current date and/or time.

In at least one embodiment, the clear button 632 additionally or alternatively is linked to the timestamp field 618, the on-the-clock field 620, and/or one or more other fields of the screenshot 600 in such a way that selecting the clear button 632 clears the timestamp field 618, the on-the-clock field 620 and/or one or more other fields of some or all of the currently entered data.

The home-navigation button 622 may be selectable to navigate to a welcome or home page. For example, if, while viewing the screen of the screenshot 600, the content producer selects the home navigation button 622, the content producer may be presented with a welcome or home page. For example, a welcome or home page presented to the content producer after selection of the home-navigation button 622 may be associated with the currently logged-in content producer (e.g., a home page including a list of some or all of the currently logged-in content producer's current, past, and/or future stories).

The hide-settings button 624 may be selectable to minimize or remove one or more settings included in the screenshot 600 and/or other settings not shown in the screenshot 600 but which are presented (e.g., after scrolling) on the page associated with the screenshot 600.

The updates button 628 may be selectable to open an update section (e.g., which may be a section of the screenshot 600 or a separate pop-up window) that allows for entry (e.g., by a content producer) of update data. In at least one embodiment, after selection of the updates button 628 and/or entry of update data in the update section, a corresponding content piece is modified to include update information based on the update data. For example, while viewing the screen of the screenshot 600, a content producer may select the updates button 628 to enter update data for a content piece and such entered update data may generate an indication on a content piece that the content piece has been updated since being published. For example, a content piece may display an indication such as “8:42 p.m.: This article was updated with additional details. This article was originally published at 7:15 p.m.” In at least one embodiment, after the update data is entered in the update-data section, the update indication is presented in the publication preview pane 650 and/or is added to a predetermined position of the previously published content piece being updated (e.g., at the beginning of the previously published content piece below the headline and/or byline, at the end of the previously published content piece, and/or any other suitable position). Such an update indication may allow content consumers to tell when (and/or to what extent) how an article has been updated since it has been published. In at least one embodiment, the update indication is added to the previously published content piece but is not presented in the publication preview pane 650.

In the depicted embodiment, the screenshot 600 includes a story-status widget 634, a save-and-continue button 636, a save-and-action widget 638, a word-count indicator 640, a page-size indicator 642, an email story button 644, and a scroll bar 646.

The story-status widget 634 may be selectable to indicate a status of a particular story being produced. In the depicted embodiment, the story-status widget 634 is selected as “working”. Such a selected value may indicate that the story for which the story-status widget 634 is selected as “working” is not ready to be published and/or may indicate that the story is not viewable by one or more content consumers. For example, the story with a story-status widget 634 selected as “working” may not be ready to be published for numerous reasons, such as for example, the story still needing to be edited, copy-edited, proofed, etc. The story-status widget 634 may alternatively be selected as “published”. For example, after a content piece is published (e.g., online, print and/or both), a content producer may update the story-status widget 634 (e.g., associated with the published content piece) from “working” to “published”.

For example, to update the story-status widget 634 from “working” to “published”, a content producer may select the story-status widget 634, which may cause the story-status widget 634 to present an option (e.g., for the content producer) to select a value of the story-status widget 634 as “published” or which may cause the value of the story-status widget 634 to be presented as “published” without further content-producer input to the story-status widget 634. As another example, after a content piece is published the story-status widget 634 may be updated from “working” to “published” automatically (e.g., without a content producer selecting the story-status widget 634 as “published”) and/or may be updated by input from one or individuals other than a content producer. Of course, the story-status widget 634 may include additional and/or alternative selectable values, as the selectable values of “working” and “published” are described and presented by way of example and not by way of limitation. For example, another selection value (e.g., “incomplete”) may help reduce inadvertent publishing of incomplete stories (e.g., since the story-status widget 634 in this example may serve as a ‘not-to-publish’ flag when selected as “incomplete”). As described in more detail below, in at least one embodiment, a value of the story-status widget 634 is presented as “updating”.

The save-and-continue button 636 may be selectable to save a content piece (e.g., being assembled for online and/or print publication and/or being updated and/or edited after publication) and/or to remain viewing the screenshot 600. For example, while viewing the screenshot 600, a content producer may select the save-and-continue button 636 to save a content piece associated with the screenshot 600 and/or to continue viewing the screenshot 600 after the content piece is saved.

The save-and-action widget 638 may be selectable to save a content piece (e.g., being assembled) and/or perform an additional and/or alternative action. While being presented with screenshot 600, a content producer may select the save-and-action widget 638 (e.g., by clicking and/or hovering, with a pointing device, on the save-and-action widget 638). Responsively, for example, the content producer may be presented with a save-action-option menu 648, which may be presented as a screen separate from the screenshot 600 or part of the screenshot 600. As depicted in FIG. 6, the save-action-option menu 648 includes the example action elements of save and: (a) “Send to Writer”, (b) “Send to Line Edit”, (c) “Send to Copy Edit”, (d) “Mark Copy Edited”, and (e) “Exit Story” (which each are referred to herein as a save-and-action element).

Various other actions could of course be included in addition to or in place of actions depicted in the save-action-option menu 648 in various different implementations. One or more of the save-action elements included in the save-action-option menu 648 may be selectable for causing performance of, at least in part, the respective save-action. In at least one embodiment, one or more save-actions corresponding to one or more save-action elements selected from the save-action-option menu 648 will automatically (e.g., without further input) be performed upon selection of the save-and-action element. In at least one other embodiment, in response to selection of a save-action-element, the save-and-action widget 638 presents save-action text corresponding to the selected save-and-action element. The save-and-action widget 638 may then be subsequently selected for performance of the presented save-action.

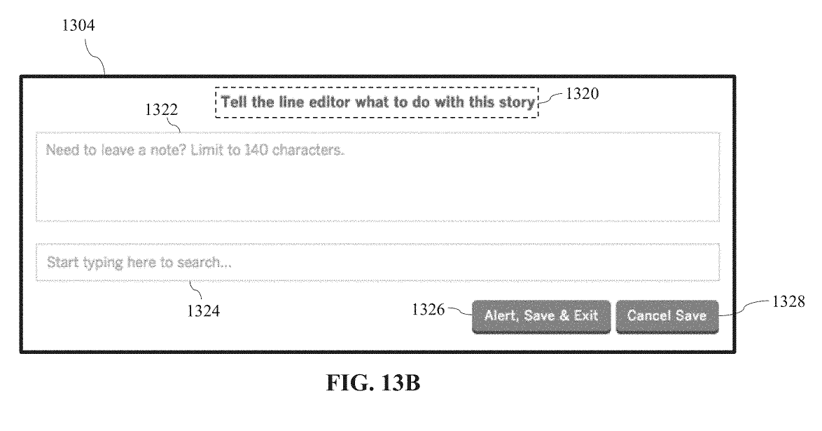

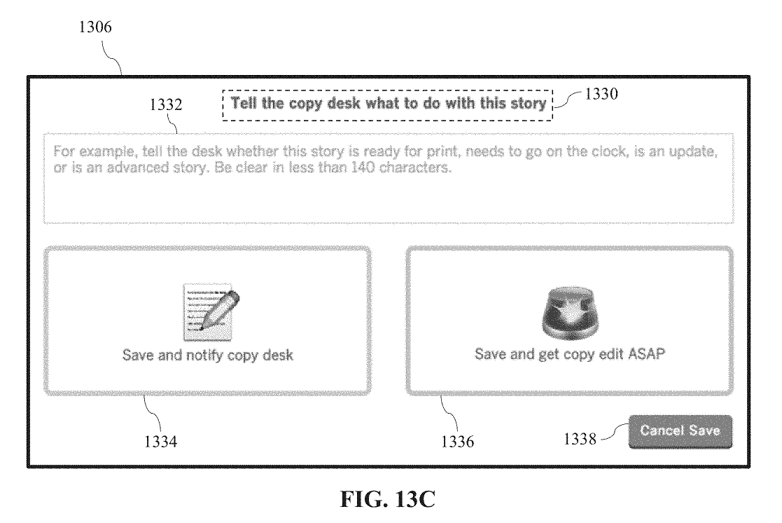

In at least one embodiment, selecting a save-and-action element presents a screen associated with the selected save-and-action element. For example, while viewing the screenshot 600, a content producer may select the save-and-send-to-writer element (e.g., after selecting the save and action widget 638 and/or being presented with the save action option menu 648), and in response to selecting the save-and-send-to-writer element, the content producer may be presented with a save-and-send-to-writer window. An example save-and-send-to-writer window in accordance with at least one embodiment is depicted in FIG. 13A and described in more detail below.

As another example, while viewing the screenshot 600, a content producer may select the save-and-send-to-line-edit element (e.g., after selecting the save-and-action widget 638 and/or being presented with the save-action-option menu 648), and in response to selecting the save and send to line edit element, the content producer may be presented with a save and send to line edit window. An example save-and-send-to-line-edit window in accordance with at least one embodiment is depicted in FIG. 13B and described in more detail below.

As another example, while viewing the screenshot 600, a content producer may select the save-and-send-to-copy-edit element (e.g., after selecting the save-and-action widget 638 and/or being presented with the save-action-option menu 648), and in response to selecting the save-and-send-to-copy-edit element, the content producer may be presented with a save-and-send-to-copy-edit window. An example save-and-send-to-copy-edit window in accordance with at least one embodiment is depicted in FIG. 13C and described in more detail below.

In at least one embodiment, one of the one or more save-action elements included in the save-action-option menu 648 is a save-and-continue element that is selectable to perform functions similar to or the same as the save-and-continue button 636. In such at least one embodiment, the screenshot 600 may not include a save-and-continue button 636 separate from the save-and-action widget 638 and/or the save-action-option menu 648. In at least one embodiment, the save-and-continue button 636 is separate from the save-and-action widget 638 and/or the save-action-option menu 648.

While viewing the screenshot 600, for example, a content producer may select the mark-copy-edited option (e.g., after selecting the save-and-action-widget 638 and/or being presented with the save-action-option menu 648), and in response to selecting the mark-copy-edited option, the corresponding story may be marked as copy-edited and/or one or more content producers may be notified via the MA 122.

In at least one embodiment, a content producer is prompted to log in to the MA 122 as part of an authentication process that may result in presentation of, for example, a home or welcome screen and/or a screen such as that depicted in FIG. 6. In at least one embodiment, content producers have the MA (application or a web counterpart) open at all times when producing content via the SUI 302. As described above, selection of the save-and-action widget 638 (or a save-action-option from the save-action-option menu 648) may cause current content-piece data to be saved and/or may cause display of a dialog box that may include an autocomplete text field allowing a content producer to find other MA users (e.g., search bar 1314 and/or search bar 1324) by, for example, name, as well display of as a message box where a content producer can add a message. Upon entry of such information, the CAP 104 calls the MA 122 via an MA-supplied API to notify the appropriate user with the appropriate message. Selecting save-and-send-to-copy-edit may function in a similar way except that the CAP 104 may be configured to receive data corresponding to an appropriate MA channel to push the notification, which may get pushed to all users in that channel Therefore, in such an example, there may only be a message box displayed to add a message that will get broadcast to the appropriate channel (e.g., instead of a subset of one or more MA application users associated with a channel).

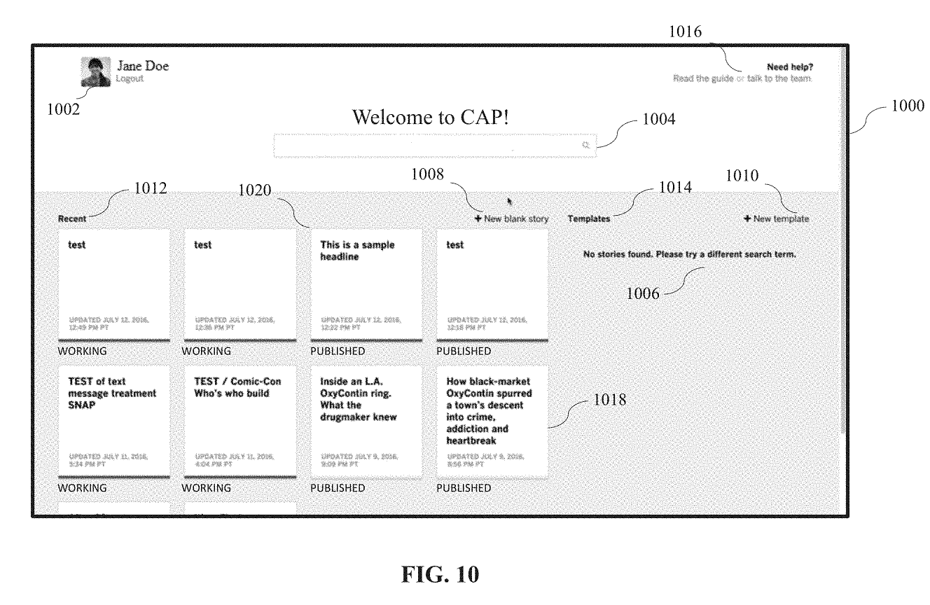

In an embodiment, selection of the-save-and-exit-story element saves the content piece and presents the content producer with another screen. For example, while viewing the screenshot 600, a content producer may select the save-and-exit-story element (e.g., after selecting the save-and-action widget 638 and/or being presented with the-save-action-option menu 648) and in response to selecting the save-and-exit-story element, the content producer may be presented with a welcome or home screen, such as, for example, the example welcome or home screens depicted in FIG. 9 and FIG. 10 and described in more detail below.

Of course one or more of the save-and-action elements included in the example save-action-option menu 648 depicted in FIG. 6 may be separate from the save-and-action widget 638 and/or the save-action-option menu 648 and may be included in a group of one or more save-and-action elements and/or one or more other elements in various other implementations.

In an embodiment, one or more of the save-action elements may be selectable to notify one or more channels (e.g., appropriate channels) in a messaging system/application (e.g., MA 122). For example, the save-action elements of save and send to writer, save and send to line edit, and/or save and send to copy edit from the save-and-action-option menu 648 may notify channels in a messaging system/application corresponding to a writer, a line editor, and a copy editor, respectively (e.g., assigned to the content piece being assembled). In at least one embodiment, one or more of the save-action elements add metadata to content of a corresponding content piece. In at least one such embodiment(s), the metadata is added so that others involved in assembling the content piece can know that the content piece is ready to be published.

One or more scrollbars 646 may be used, for example, to alter the content presented via the SUI 302 that is visible to one or more content producers. It is noted that one or more additional regions, one or more additional data-entry fields, one or more additional buttons, and/or one or more additional widgets may become visible and/or selectable to the content producer viewing the screen by employing a scrollbar 646. In at least one embodiment, the scrollbar 646 is configured to control a section of the SUI 302 to the right or the left of the scrollbar 646.

The publication preview pane 650 may present, at least in part, content based on values of one or more data-entry elements (or lack thereof), for example, entered by a content producer and/or predetermined and set as a default. The publication preview pane 650 may be configured to present content responsive to data entered in to the one or more data-entry elements and in a manner based on predetermined content-display rules. For example, as a content producer enters a headline into the headline field 602, such a change in the headline field 602 may be detected and the publication preview pane may responsively display a publication-style headline based on the entered headline.

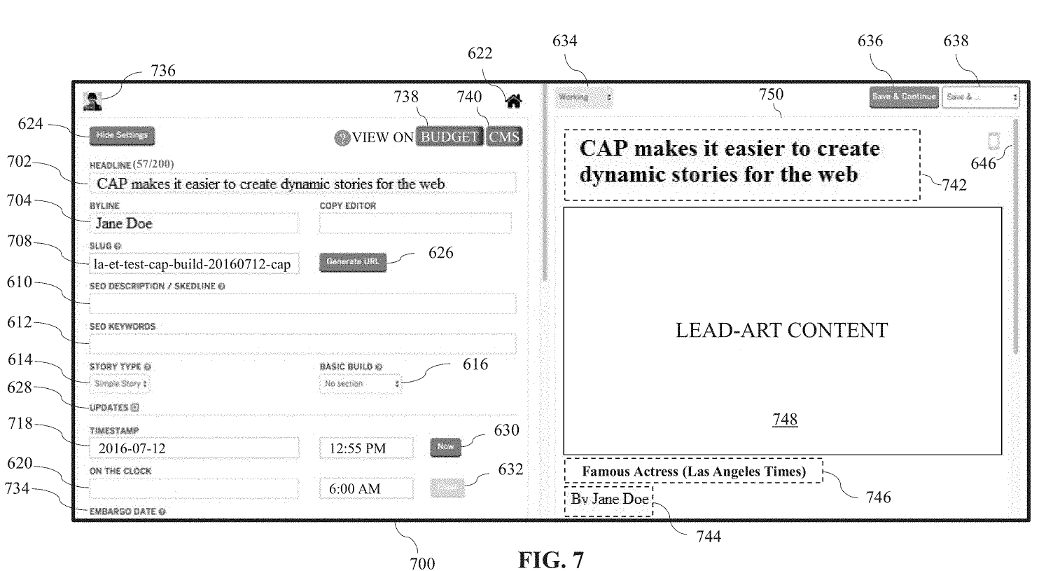

FIG. 7 depicts a second example screenshot of the SUI 302 presented by the content assembly platform (CAP) 104 of FIG. 1, in accordance with at least one embodiment. The screenshot 700 of FIG. 7 shows all the data entry elements that are shown in screenshot 600 of FIG. 6, though with example data values filled in for some of the various data fields, and additionally shows an embargo-date field 734, a content-producer account identifier 736, a budget button 740, and a CMS button 746. In at least one embodiment, clicking the budget button 740 creates an additional screen (e.g., a new browser window) that opens a login page to a budgeting system. Successful login to the budgeting system may take a content producer to a view of the corresponding content piece in the budgeting system (e.g., a screen of the budgeting system corresponding, at least in part, to the content piece. In at least one embodiment, clicking the CMS button 746 operates similarly as clicking the budget button 740, except instead of a budgeting system being logged into and displayed, a content-management system (e.g., a proprietary CMS such as PSP) is logged into and displayed.

In the embodiment depicted, an example headline (e.g., “CAP makes it easier to create dynamic stories for the web”) is included in the in the headline field 702. As shown in FIG. 7, the text included in the headline field 702 is presented in a section 742 of the publication preview pane 750. In at least one embodiment, the manner in which the headline in the section 742 is presented in the publication preview pane 750 is based on a set of predetermined content-display rules. The set of predetermined content-display rules may include rules directed to any number of content-display characteristics. For example, the content-display rules may dictate one or more of content size, content color, content style, content position, content resolution, and/or relational position of content elements, among numerous other possibilities.

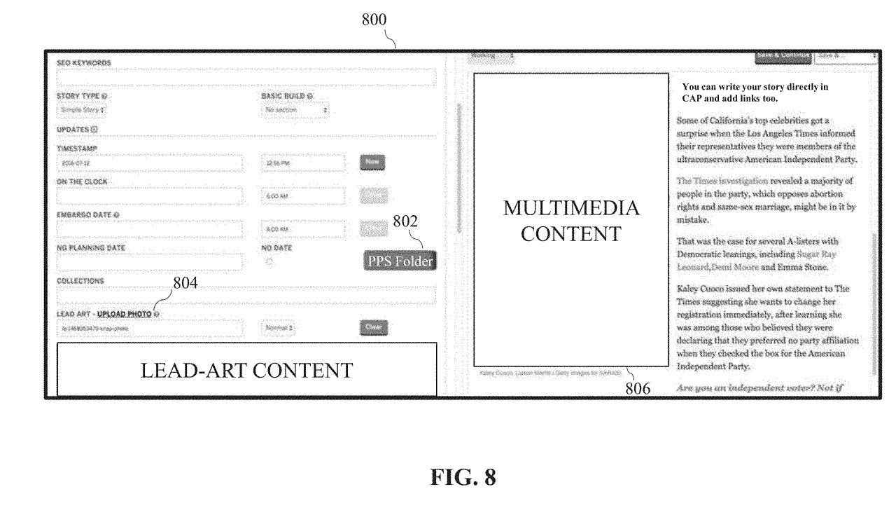

FIG. 8 depicts a third example screenshot of the SUI 302 presented by the content assembly platform (CAP) 104 of FIG. 1, in accordance with at least one embodiment. The screenshot 800 of FIG. 8 includes many of the data-entry elements from the screenshot 600 of FIG. 6 and the screenshot of FIG. 7 (e.g., one or more buttons, data-entry fields, and/or widgets) described above and additionally includes a PPS-folder button 802, a PPS-planning-date field 804, a collections field 806, and an upload-photo button 808. The PPS-folder button 802 may be selectable to take a content producer to a screen presenting a PPS user interface. The PPS-planning-date field 804 may be a free-text field which allows entry of date data corresponding to a date which a corresponding content piece is planned for print-publication and/or is planned for submission to a PPS for print-publication.

FIG. 9 depicts a fourth example screenshot of the SUI 302 presented by the content assembly platform (CAP) 104 of FIG. 1, in accordance with at least one embodiment. The screenshot 900 of FIG. 9 may be presented, for example, to a content producer after first passing through one or more conventional HTML screens directing the content producer through activities such as logging in to an account. The screenshot 900 may be, for example, a welcome or home screen. In such an example, the screenshot 900 may be presented to a content producer after occurrence of one or more predefined welcome/home screen-presentation triggering events. For example, in an example implementation where the screenshot 900 is a welcome or home screen, the screenshot 900 may be presented after welcome/home screen-presentation triggering events, such as, a content producer logging into an account, a content producer selecting a home-navigation button (e.g., the home navigation button 622 of FIG. 6), presentation of another screen for greater than a threshold amount of time, and/or any other suitable event as is known to those having ordinary skill in the art.

The screenshot 900 may, for example, serve as a centralized screen through which a content producer can perform a variety of content production related tasks. In at least one embodiment, the screenshot 900 is presented to allow a content producer to create new stories, create new templates, search for previously created stories and/or templates, view and/or organize previously created stories, and/or contact a support source. The screenshot 900 of FIG. 9 includes content-producer-related information 902, search-entry element 904, search-results section 906, new-blank-story element 908, new-template-element 910, recent-collection section 912, templates section 914 and/or contact element 916.

The content-producer-related information 902 may take a variety of forms. In at least one embodiment, the content-prouder-related information 902 is or includes a profile picture, a name, an icon, and/or the like associated with a currently logged-in account of a corresponding content-producer. In at least one embodiment, the screenshot 900 is presented including the content-producer-related information 902 after an account associated with a corresponding content producer is logged into. For example, after logging into an account associated with a corresponding content producer, the corresponding content producer may be presented with the screenshot 900, which in this example, includes content-producer related information 902 that is based on the currently logged-in account.

The search-entry element 904 may take a variety of forms. In at least one embodiment, the search entry element 904 allows a content producer to search for one or more content pieces and/or content-piece-related items. For example, a content producer may search for one or more content pieces such as, for example, one or more published content pieces, one or more working content pieces, and/or one or more pending content pieces, among other types of content pieces. For example, a content producer may search for one or more content-piece-related items, such as, for example, templates, images, videos, articles, and/or any other information that the content producer may use to produce content.

To search for one or more content pieces and/or content-piece-related items, the content producer may enter content search data via the search-entry element 904. In at least one embodiment, the search-entry element 904 allows for searching, for one or more content pieces and/or content-piece-related items, via entry of content search data that is or includes slugs corresponding to the respective content pieces and/or content-piece related items. For example, the search-entry element 904 may allow a content producer to search for a previously created content piece by entering a slug corresponding to the previously created content piece. In at least one embodiment, the search-entry element 904 is or includes a search bar, and content search data is, at least in part, entered by typing alphanumeric characters into the search bar. However, the search-entry element 904 may be or include another form deemed suitable by those of skill in the art, and/or the content search data may be entered via any technique deemed suitable by those of skill in the art.

In at least one embodiment, results based on searches conducted via the search-entry element 904 are presented in the search results section 906. The search-entry element 904 may be, for example, configured to receive content search data and cause presentation of results based on the received content search data, which may be carried out by one or more manners conventional in the art. In at least one embodiment, the search-entry element 904 is configured to receive a unique identifier and/or a headline associated with a content piece. In an example scenario, a content producer may desire to view a content piece that was previously created. In such an example scenario, the previously created content piece may be associated with a unique identifier (e.g., an alphanumeric slug); and to view the previously created content piece, the content producer may search for the previously created content piece by entering the unique identifier into the search-entry element 904 and/or subsequently viewing results based on the search in the search-results section 906.

Results presented in the search-results section 906 may be or include, for example, text, images, videos, links, audio, and/or the like, that may be retrievable through use of the search-entry element 904. For example, based on the content search data, the search-results section 906 may present portions and/or thumbnails of previously created content pieces and/or templates, content used within such content pieces and/or templates, other content that may be accessible and/or retrievable, and/or alerts. For example, the search-results section 906 may present an alert that no results were retrieved based on the entered content search data.

New-blank-story element 908 may be selectable to provide a screen for creating a new story/content piece, such as, for example, a screen similar to or the same as, at least in part, the screen shown in screenshot 600 of FIG. 6. A screen for creating a new story/content piece provided after selecting the new-blank-story element 908 may include a variety of data-entry elements and/or sections, among other components, and the components may be included based on data related to one or more content producers (e.g., a currently logged in content producer, a particular newsdesk, a particular newsroom, etc.).

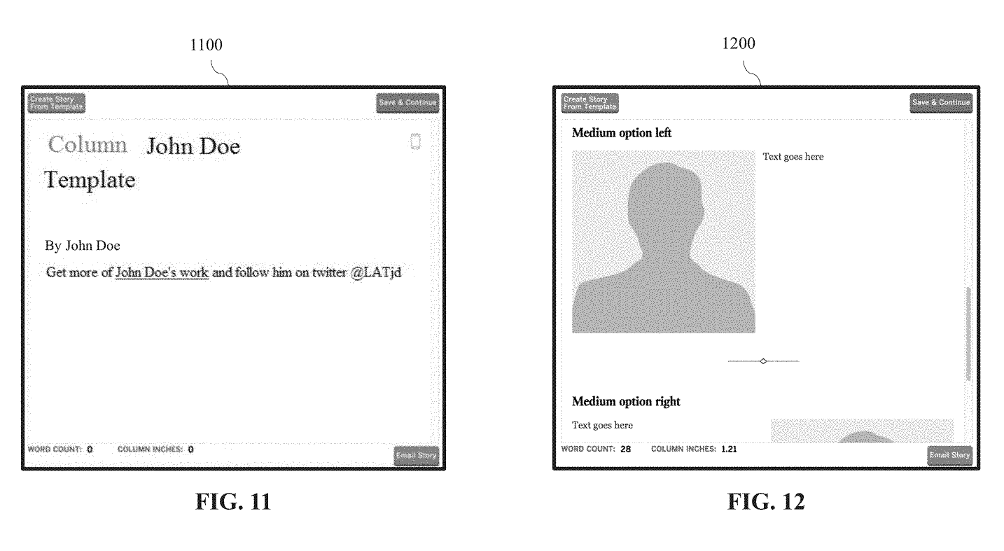

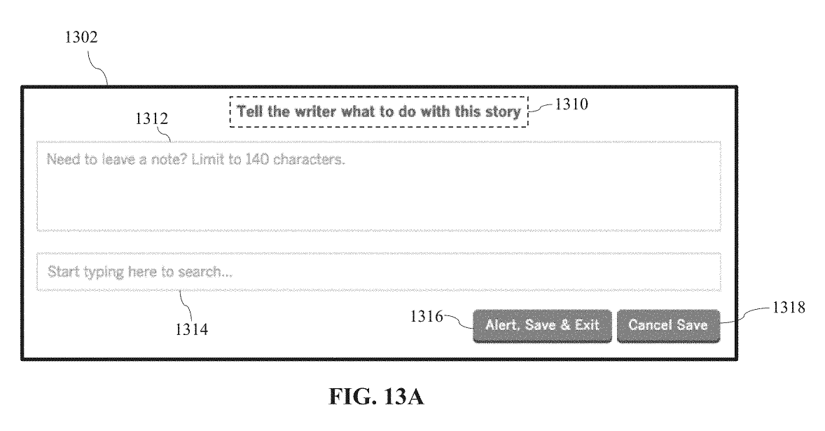

New-template element 910 may be selected to provide a screen for creating a new template, such as, for example, a screen similar to or the same as, at least in part, one or more of FIG. 11 and/or FIG. 12. A screen for creating a new template provided after selecting the new-template element 910 may include a variety of data-entry elements and/or publication preview panes, among other components, which may be modified by a content producer and/or retrievable for later use.

Recent-collection section 912 may be a section of the screenshot 900 that presents recent content piece data corresponding to one or more respective content pieces. In at least one embodiment, the recent-collection section 912 includes a preview of and/or link to each of one or more recent content pieces. For example, a preview of each of one or more recent content pieces (e.g., content pieces recently created and/or updated) may be presented in the recent-collection section 912 and/or one or more links may be presented in the recent-collection section 912 that are selectable to access one or more corresponding recent content pieces. In at least one embodiment, the preview of the one or more recent content pieces presented in the recent-collection section 912 is a link selectable to present the corresponding recent content piece.

Templates section 914 may be or may include previously created templates that may be used, for example, to create content pieces. Templates section 914 may be or may include a link to each of the previously created templates. In at least one embodiment where the templates section 914 itself is a selectable element, selecting the templates section 914 takes a content producer to a screen including a section similar to the recent-collection section 912, except this section would include a preview and/or a link to one or more previously created templates.

In at least one embodiment, the contact/help element 916 allows a content producer to contact one or more other content producers, one or more technical-support members, and/or other individuals/entities. The contact/help element 916 may be selectable for a content producer to request and/or receive help regarding a content piece, for example, from one or more other content producers and/or other individuals/entities, among other sources. In at least one embodiment, after selecting the contact/help element 916, a contact window is presented which allows for messaging between the content producer and the contacted individual/entity. The presented contact window may be presented as a separate window from the screenshot 900 or may be presented as a section within a single window of the screenshot 900. The contact/help element 916 may allow a content producer to access a FAQ link, a content-production guide, a content-production system guide, and/or any other information that may be helpful for producing online and/or print content.

FIG. 10 depicts a fifth example screenshot of the SUI 302 presented by the content assembly platform (CAP) 104 of FIG. 1, in accordance with at least one embodiment. FIG. 10 depicts an example screenshot 1000 including example values and/or representations for the elements and sections depicted in the screenshot 900 of FIG. 9. For example, content-producer-related information 1002 may be presented in the form of the name “Jane Doe” which may be a name of a content producer associated with a currently logged-in account and/or may be presented in the form of a profile picture associated with the currently logged in account.

In the depicted embodiment, search-entry element 1004 takes the form of a search bar. The search bar may accept textual input and/or may allow for searching by a unique identifier of a content piece and/or a headline of a content piece.

In the depicted embodiment, search-results section 1006 is a pane which displays example results indicative of an unsuccessful search for a story. The depicted example search-results section 1006 displays the text “No stories found. Please try a different search term.”

In the depicted embodiment, new-blank-story element 1008 and/or new-template element 1010 are hypertext links and/or buttons for causing presentation of a new-story-creation screen and/or a new-template-creation screen, respectively.

In the depicted embodiment, recent-collection section 1012 includes eight recent content piece display elements. Some of the recent content piece display elements presented in the recent-collection section 1012 may be, for example, representative of respective content pieces at a stage in the content-creation process (e.g., recent working content pieces which may be in a drafting stage prior to, for example, editing and/or copy editing); while some other content piece elements presented in the recent-collection section 1012 may be, for example, representative of respective content pieces at another stage in the content-creation process (e.g., recent pending content pieces which may be in an editing/review stage, for example, prior to publishing and/or after editing and/or copy editing). In the depicted embodiment, each of the content piece display elements includes a corresponding headline (e.g., which may be presented as a result of data entered into a headline field, such as headline field 602, while a screen, such as the screen depicted in one or more of screenshot 600 of FIG. 6 and/or screenshot 700 of FIG. 7, was presented), a status identifier corresponding to the content piece associated with the respective content piece display element (e.g., working, pending, etc., which may be presented as a result of a selection of a story-status widget, such as story-status widget 634 of FIG. 6), and/or an updated time/date identifier.

In the depicted embodiment, example content-piece-display element 1020 includes example corresponding headline presented as “This is a sample headline”, an example status identifier presented as “WORKING”, and an updated-time/date identifier presented as “UPDATED JULY 12, 2016 12:36 PM PT”. In the depicted embodiment, example content-piece-display element 1018 includes example values different than those of display element 1020. The example content piece display element 1018 includes a status identifier presented as “PENDING”, which may be indicative of the content piece associated with content-piece-display element 1018 being at a stage in the content-creation process different than the content piece associated with the content-piece-display element 1020. A content producer, while viewing the screen of screenshot 1000 may select, for example, a content-piece-display element and subsequently may be presented with a screen displaying additional details of the content piece associated with the selected content piece display element.

In the depicted embodiment, templates section 1014 may be the same as templates section 914 described above in connection with FIG. 9.

Contact/help element 1016 may take the form of a link to a guide, for example, for using one or more features of embodiments of systems and methods described herein. The guide may be, for example, at least one user manual, at least one frequently asked questions (FAQ) page, at least one page including, referencing, and/or linking to resources useful for a content producer to implement one or more embodiments of systems and methods described herein, and/or the like. The contact/help element 1016 may additionally and/or alternatively take the form of a link to a messaging application that functions as described herein. For example, the contact/help element 1016 may provide an integrated mechanism for a contact producer to receive assistance assembling content via a messaging application (e.g., voice communication, instant messaging, video conferencing, etc.).

FIG. 11 depicts a sixth example screenshot of the SUI 302 presented by the CAP 104 of FIG. 1, in accordance with at least one embodiment. While viewing the screenshot 900 of FIG. 9 and/or the screenshot 1000 of FIG. 10, a content producer may select a template included in the template section 914 and/or a template included in the template section 1014, respectively, which may take the content producer to the screenshot 1100.

The screenshot 1100 of FIG. 11 depicts an example template that may be used by a content producer to facilitate creation of a content piece. The example template may allow a content producer to set a slug prefix, a byline, collections, kickers, and/or select (and/or input) various other content-production related values. By starting with a template such as the template depicted in FIG. 11, in some example implementations of systems and methods described herein, content producers may easily create a content piece pre-loaded with a variety of options. Templates may be developed for use by content producers in such a way that encourages more visual and/or creative story telling. For example, certain fonts, text styles, text sizes, text color, content placement, content type, and/or background and foreground contrast, among numerous other display options, may be selected for inclusion in a template and/or may facilitate creation of engaging content. While being presented with the example screenshot 1100 of FIG. 11, a content producer may, for example, create a story from the presented template (e.g., by selecting an element such as, for example, the “create story from template” element displayed with the template) and/or may, for example, save the template for use, revision, completion, etc. at another time (e.g., by selecting an element such as, for example, the “Save & Continue” element displayed with the template).

FIG. 12 depicts a seventh example screenshot of the SUI 302 presented by the CAP 104 of FIG. 1, in accordance with at least one embodiment. The screenshot 1200 of FIG. 12 depicts an example template that, as explained above in connection with the screenshot 1100 of FIG. 11, may be used by a content producer to facilitate creation of a content piece. The screenshot 1200 of FIG. 12 may be, for example, of a template different from the template depicted in FIG. 11 and/or may include additional and/or alternative display options than the template depicted in FIG. 11. As another example, FIG. 12 may be the same template as the template depicted in FIG. 11 but may depict another portion (e.g., a portion scrolled to by a content producer) of the template of FIG. 11. While viewing the screenshot 900 of FIG. 9 and/or the screenshot 1000 of FIG. 10, a content producer may select a template included in the template section 914 and/or a template included in the template section 1014, respectively, which may take the contact producer to the screenshot 1200.

FIG. 13A depicts an example writer-alert window of the SUI 302 presented by the CAP 104 of FIG. 1, in accordance with at least one embodiment. FIG. 13A depicts an example writer-alert window 1302 that may be, for example, presented after selection of a save-and-send-to-writer element (e.g., the-save-and-send-to-writer element described above in connection with FIG. 6). While viewing, for example, the screenshot 600 of FIG. 6, a content producer may select the save-and-send-to-writer element. In at least one embodiment, in response to selection of the-save-and-send-to-writer element, the writer-alert window depicted 1302 is presented with the screenshot 600. For example, the writer-alert window 1302 may be presented as a modal box or may be presented as a page separate from the screenshot 600.

The writer-alert window 1302 may include, for example, one or more elements for providing information to one or more writers and/or other content producers. The depicted embodiment of the example writer-alert window 1302 includes a header 1310, a text-entry area 1312, a search bar 1314, an alert-save-exit button 1316, and a cancel-save button 1318. The header 1310 may be, for example, introductory information that may be associated with the writer-alert window 1302. As depicted, the header 1310 includes the text “Tell the writer what to do with this story”. In at least one embodiment, the writer-alert window does not include a header 1310.

In at least one embodiment, a content producer (e.g., an editor, a proofer, etc.) reviews and/or modifies in some manner a content piece being assembled or a published content piece possibly being updated. The content producer that reviewed and/or modified the content piece may, for example, provide information to one or more other content producers (e.g., one or more writers) via the writer-alert window 1302. For example, the content producer that modified the content piece may enter text into the text-entry area 1312 and/or such text may be subsequently provided to one or more other content producers (and/or possibly to the content producer that modified the content piece). The text entered in to the text-entry area 1312 may be information corresponding to, for example, one or more modifications made by the content producer, one or more modifications still needed and/or desired to be made to the content piece, a content producer's schedule, availability and/or workload, one or more deadlines, an estimated time of completion of the content piece and/or one or more tasks associated with the content piece, among any other information.

In at least one embodiment, the text-entry area 1312 includes a list of one or more selectable preconfigured notes (e.g., “good work”, “this looks good”, “I will be out of the office starting next week”, etc.) and/or other information. In at least one embodiment, a content producer need not enter any text in the text-entry area 1312 and/or there need not be any text entered in the text-entry area 1312 for the content producer to alert one or more other content producers of modifications associated with the content piece. In at least one embodiment, the text-entry area 1312 is not included in the writer-alert window 1302.

The one or more content producers that may be alerted of the information provided by the content producer (e.g., information entered in to the text-entry area 1312) may be selected via the search bar 1314. For example, the content producer may search for the one or more other content producers to alert using the search bar 1314, which may populate results of individual content producers and/or groups of content producers. In at least one embodiment, the search bar 1314 allows a content producer to search for at least a subset of all content producers associated with production of the associated content piece. The search bar 1314 may be configured to be or include a filter list for presenting search results. Of course, in various different implementations, the search bar 1314 can be configured in such a way that a content producer can search for content producers based on a variety of different search terms.

FIG. 13B depicts an example line-edit-alert window 1304 of the SUI 302 presented by the CAP 104 of FIG. 1, in accordance with at least one embodiment. The depicted example line-edit-alert window 1304 may be, for example, presented after selection of a save-and-send-to-line-edit element (e.g., the save-and-send-to-line-edit element described above in connection with FIG. 6). The line-edit-alert window may include, for example, one or more elements for providing information to one or more editors and/or other content producers. In the depicted embodiment, the line-edit-alert window 1304 includes a header 1320, a text-entry area 1322, a search bar 1324, an alert-save-exit button 1326, and a cancel-save button 1328, which may function similarly as respective elements of the writer-alert window described above in connection with FIG. 13A.

The writer-alert window 1302 and the line-edit-alert window 1304 may differ, for example, with respect to which content producers are notified via the respective windows. For example, search terms may be entered in to the search bar 1314 to search a list of or related to writers associated with a content piece, while search terms may be entered in to the search bar 1324 to search a list of or related to editors associated with a content piece. However, in at least one embodiment, entering search terms in to the search bar 1314 or the search bar 1324 searches the same list of content producers.

FIG. 13C depicts an example copy-desk-alert window 1306 of the SUI 302 presented by the CAP 104 of FIG. 1, in accordance with at least one embodiment. FIG. 13C depicts an example copy-desk-alert window 1306 that may be, for example, presented after selection of a save-and-send-to-copy-edit element (e.g., the save-and-send-to-copy-edit element described above in connection with FIG. 6). While viewing, for example, the screenshot 600 of FIG. 6, a content producer may select the save-and-send-to-copy edit element. In at least one embodiment, in response to selection of the save-and-send-to-copy-edit element, a copy-desk-alert window 1306 is presented with the screenshot 600. The copy-desk-alert window 1306 may include, for example, one or more elements for providing information to one or more copy desks, one or more content producers associated with the one or more copy desks, and/or one or more other content producers.

The depicted example copy-desk-alert window 1306 includes a header 1330, a text-entry area 1332, a save-and-notify-copy-desk button 1334, a save-and-get-copy-edit-ASAP button 1336, and a cancel-save button 1338. The header 1330 may be similar to the header 1310 described above in connection with FIG. 13A.

The text-entry area 1332 may function similarly to or the same as the text-entry area 1312 described above in connection with FIG. 13A. A content producer may enter text in the text-area 1332 to alert a copy desk. For example, a content producer may enter text in the text area 1332 to alert a copy desk as to whether the corresponding story is ready for print, needs to go on the clock, is an update, or is an advanced story. In at least one embodiment, a content producer need not enter text in to the text-area 1332 and/or text need not be entered in to the text-area 1332 for a content producer to select the save-and-notify-copy-desk button 1334 or the save-and-get-copy-edit-ASAP button 1336.

The cancel-save button 1338, for example, may function similar to or the same as the cancel save button 1318 described above in connection with FIG. 13A and/or may function in any suitable manner.

The save-and-notify-copy-desk button 1334 and/or the save-and-get-copy-edit-ASAP button 1336 may be selectable, for example, to cause saving of a corresponding story and/or sending of a notification to one or more copy desks, one or more content producers associated with the one or more copy desks, and/or one or more other content producers. In at least one embodiment, a content producer selects either the save-and-notify-copy-desk button 1334, the save-and-get-copy-edit-ASAP 1336 button, or the cancel-save button 1338 depending on one or more content piece production characteristics of the corresponding content piece. For example, a content producer may select either of these buttons depending on a content piece production characteristic of the corresponding content piece such as an urgency of publishing the content piece (online and/or in print).

If a content piece is considered to be, for example, urgent, a content producer may select the save-and-get-copy-edit-ASAP button 1336. If a content piece is not considered to be urgent or is considered to be less urgent than other content pieces, a content producer may select the save-and-notify-copy-desk button 1334.

In response to the content producer selecting the save-and-notify-copy-desk button 1334 or the save-and-get-copy-edit-ASAP button 1336, a copy desk associated with the corresponding content piece may be notified via the MA 122. For example, selecting the save-and-notify-copy-desk button 1334 or the save-and-get-copy-edit-ASAP button 1336, may cause a messaging application (e.g., the MA 122) to present content piece related information. For example, after such a button is selected, the MA 122 may present a slug corresponding to the content piece, a status corresponding to the content piece, a publish time corresponding to the content piece, an urgency indicator corresponding to the content piece, a note corresponding to the content piece, among numerous other content piece related information.

As a result of communication between the CAP 102 and the MA 122, the MA 122 may present the content piece related information based on, for example, values entered in the one or more data entry elements of the SUI 302. For example, based on text entered in to the text-entry field 1332, the MA 122 may present a note to the corresponding copy desk, which may be presented with other content piece related information.

For example, based on selection of the save-and-notify-copy-desk button 1334 or the save-and-get-copy-edit-ASAP button 1336, the MA 122 may present an urgency indicator to the copy desk. For example, if a content producer selects the save-and-notify-copy-desk button 1334, the MA 122 may present, as an urgency indicator, the pencil-and-paper icon depicted in the example save-and-notify-copy-desk button 1334 in FIG. 13C, and such an urgency indictor may represent no or low urgency. For example, if a content producer selects the save-and-get-copy-edit-ASAP button 1336, the MA 122 may present, as an urgency indicator, the beacon icon depicted in the example save-and-get-copy-edit-ASAP button 1336 of FIG. 13C, and such an urgency indicator may represent high urgency. As another example, based on value of a slug field (e.g., the slug field 608), the MA 122 may present a slug to the copy desk.

In at least one embodiment, a subset of a set of one or more copy desks are notified after selection of the save-and-notify-copy-desk button 1334 or the save-and-get-copy-edit-ASAP button 1336. The subset of copy desks that are notified as a result of such a selection may be based upon, for example, content piece related information. For example, based on one or more values included in the data-entry elements of the SUI 302 for a content piece, the subset of copy desks may be notified. In at least one embodiment, the subset of copy desks are keyed off the value of the slug field 608, which has a prefix taxonomy. For example, notifications corresponding to a story that has a slug with a prefix of “la-sp” (e.g., has a slug field 608 with a value starting with “la-sp”) would get routed to the LA Times sports copy desk. As another example, a sports copy desk may be notified if the basic build widget 614 has a value of sports build.

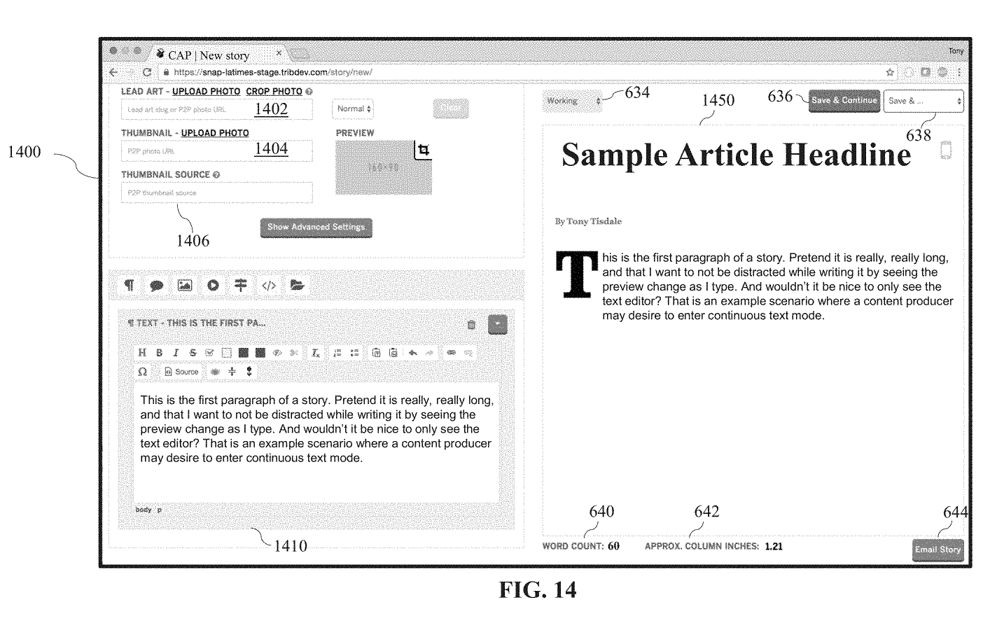

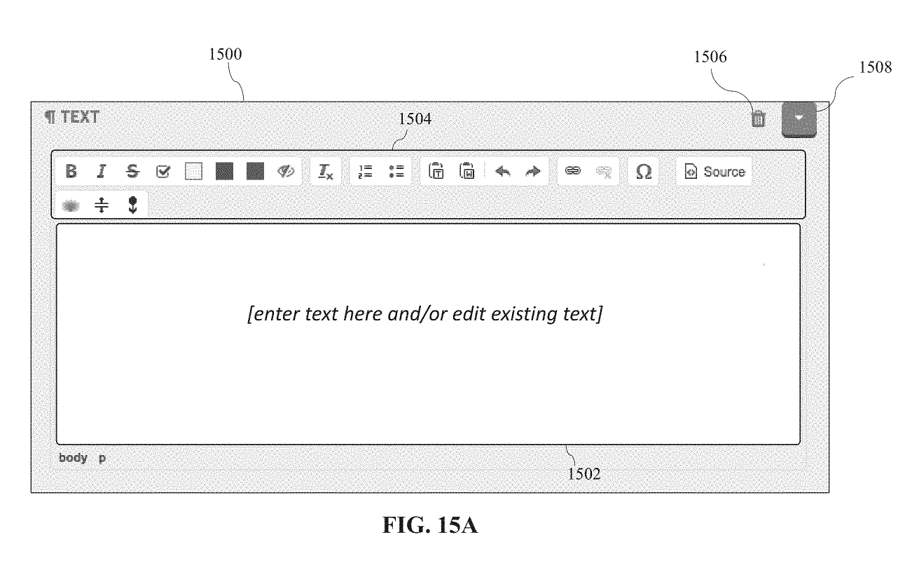

FIG. 14 depicts an eighth example screenshot of the SUI 302 presented by the CAP 104 of FIG. 1, in accordance with at least one embodiment. The screenshot 1400 includes, among other elements, a lead-art-upload/crop element 1402, a thumbnail-upload element 1404, and a thumbnail-source element 1406. The depicted embodiment may, for example, represent a screenshot of the screen of FIG. 6 having been scrolled down to another part of the screen.

The lead-art-upload/crop element 1402 may be selected to upload a lead-art photo that may be the first presented photo of a content piece and/or may be adjacent to a heading of a content piece. Selecting the upload-photo button of the lead-art-upload/crop element 1402 may allow a content producer to upload a photo, which may be cropped using the crop-photo button of the lead-art-upload/crop element 1402. The thumbnail-upload element 1404 and the thumbnail-source element 1406 may allow for a content producer to upload a thumbnail and add data corresponding to a source of the photo represented by the thumbnail. An example lead-art photo that may be uploaded with the lead-art-upload/crop element 1402 is depicted in FIG. 7 as lead-art content 748.

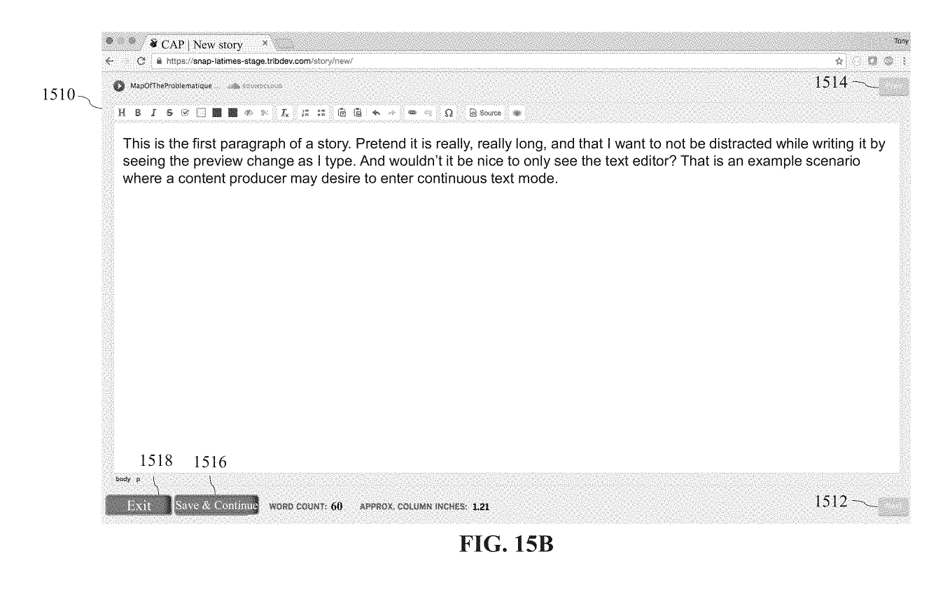

FIG. 15A depicts a ninth example screenshot of the SUI 302 presented by the CAP 104 of FIG. 1, in accordance with at least one embodiment. The screenshot 1500 of FIG. 15A includes a text-area 1502, text-editing tool pane 1504, trash element 1506, and/or toggle element 1508. The screenshot 1500 depicts an example text editing screen that may include one or more elements/features allowing text of a content piece to be entered and/or edited, as well as allowing for other content-piece-related editing functions. The text editing screen may, for example, represent a text-editing widget in an expanded form (as opposed to a collapsed form). The text-editing widget of the text-editing screen, for example, may be used to create text content of a content piece, track edits throughout at least part of a process of creating and/or assembling content of a content piece, and/or provide note(s) to one or more content producers.

The text-editing screen may include one or more elements/features that, for example, allow for entering and/or editing of, for example, traditional line and/or copyediting mark(s), blue note(s), plum note(s), content producer comment(s), trim(s), and/or CQ (cadit quaestio) of name(s). In at least one embodiment, changes made to text in the content piece text component 1502 are tracked. For example, while viewing the screenshot 1500, a content producer may make one or more changes to text content present in the text-area 1502, and/or the CAP 104 may be configured to track such changes. The content producer may make such changes, at least in part, for example, by selecting one or more text-editing tools included in the text-editing tool pane 1504.

In the depicted embodiment, the text-editing tool pane 1504 includes the following selectable elements (elements listed in order from left to right and top to bottom): bold, italics, strikethrough, CQ, highlight, blue note, plum note, show/hide revisions, clear formatting, numbering, bullets, paste with source formatting, paste with default formatting, undo, redo, add link, remove link, special character, show/hide source code, continuous text mode, widget split, and merge down. Bold, italics, bullets, paste with source formatting, paste with default formatting, undo, and/or redo may function as corresponding, traditional word-processor features function.

The strikethrough element may be selectable to strike through text that is present in, for example, a text area of a text widget. For example, a content producer may select text in a text area (e.g., by highlighting such text) and/or may select the strikethrough element (e.g., prior to or after selecting the text). In such an example, the selected text may be removed from the publication preview pane 650 and/or may be present as text in the text area but now with a strikethrough the text. Editing text content using the strikethrough element may create an edit trail that may allow one or more content producers to track edits made to text during creation of content of a content piece. Presentation of text that is edited using the strikethrough element may be based on an identity of a content producer (e.g., as indicated by a name associated with a currently logged-in account). Text that is edited using the strikethrough element by one content producer (e.g., a copy editor) may be presented differently (e.g., in a different color, different font size, different font type, etc.) than text that is edited using the strikethrough element by another content producer (e.g., a line editor).

In the depicted embodiment, the CQ element is represented by a button with a checked box. The CQ element may be, for example, selectable for indicating that text has been checked. Text that has been checked may be, for example, text that has been reviewed, verified, validated, etc. for accuracy, spelling, grammar, and/or typos. For example, to indicate that text has been checked, a content producer may select the CQ element, and in response to this selection, a checked indicator may be presented indicating that the text has been checked. In at least one embodiment, selecting the CQ element is indicative that all of the text presented in the text-area 1502 has been checked. As a further example, a content producer viewing the screenshot 1500 may be copy-editing at least some of the text content presented in the text-area 1502 and that was previously entered by another content producer. In such a further example, the content producer that is copy-editing the text, may select the CQ element and the text widget may be marked as checked.

The highlight element may be selectable to highlight text which is to be (and/or remain being) presented in a text widget but is not to be (and/or not remain being) presented in the publication preview pane 650 and/or displayed in a published version of the content piece. The highlight element may allow a content producer to leave a note, for example, for another content producer. For example, a content producer editing content of a content piece may use the highlight element to add a note (e.g., “Can you find more detail on this topic?”) for another content producer (e.g., responsible for incorporating the editor's feedback) that may not be presented in the publication preview pane 650 but may be presented elsewhere on the screen (e.g., in the text-area 1502). Such presentation of the note may allow for a content producer to leave a note for another content producer without affecting presentation of content of a content piece in the publication preview pane 650 and/or without affecting either content producer's ability to view content of a content piece in the publication preview pane 650.

The blue-note element and the plum-note element may be selectable to respectively add a blue note and a plum note as is known to those having ordinary skill in the art. A blue note may be added to text to indicate that such text was reviewed and/or edited in a certain manner, while a purple note may be added to text to indicate that such text was reviewed and/or edited in a different manner.

For example, text may be selected and/or the blue-note element may be selected to add a blue note to the selected text, which may, for example, change the selected text's color to blue (or another color if the text is already blue) as presented in the corresponding text widget. In such an example, the corresponding text presented in the publication preview pane 650 may remain unchanged and/or may not be affected by the addition of the blue note. The blue-note element may be employed, for example, by a copy editor (and/or other content producers) to add a blue note to text that indicates that such text has been copy-edited, proofed, or otherwise corrected.

A purple note may be added to text in the same or similar manner as adding a blue note to text. A difference may be that adding a purple note may change the selected text's color to purple (or another color if the text is already purple). The purple-note element may be employed, for example, by a line editor (and/or other content producers) to add a purple note to text that indicates that such text has been lined edited.

In the depicted embodiment, the show/hide revisions element is represented as an eye having a slash through the eye. The show/hide revisions element may be selectable, for example, to show and/or hide revisions to text of a text widget. For example, selecting the show/hide revisions element may remove all text from a text area of a text widget that is not content of a content piece. For example, text which has a strikethrough, text which is highlighted, trim text, and/or any other text which is not text content may be removed from the text widget. Selecting the show/hide revisions element may allow for a view of the text area, unobstructed from editing (e.g., heavy editing) that may have been previously made to the corresponding text area by one or more content producers.

In the depicted embodiment, the clear-formatting element is represented as an underlined “T” with an “x” subscript. The clear-formatting element may be selectable, for example, to remove formatting of text in a text widget. In some scenarios, selecting the clear-formatting element may, for example, cause text that was not previously displayed in the publication preview pane 650 to be displayed in the publication preview pane 650. In at least one embodiment, to be able to clear the formatting of text in a text widget, that text must be selected. For example, as set forth above, text that is selected with the highlight element may not be presented in the publication preview pane 650 and/or displayed in a published version of the content piece; however, selecting such highlighted text and/or selecting the clear-formatting element may remove the highlighting and associated attributes from the selected text. Accordingly, such text may then be presented in the publication preview pane. In at least one embodiment, selecting the clear-formatting element clears all formatting of text in the text widget.

The add-link element may be selectable to add links to content of a content piece, for example, from one or more other content sources (e.g., a third party website, a related content piece, etc.). For example, text may be selected in a text widget and/or the add-link element may be selected to create a link to a page from the selected text.

The remove-link element may be selectable to remove a link, for example, that was added to text of a text widget via the add-link element.

The special-character element may be selectable to, for example, insert symbols into a text widget. For example, a content producer may desire to include a symbol as part of content of a content piece. A content producer may select special-character element, which may present a special-character picker that may include a list of one or more symbols that may be inserted into a text widget. In at least one embodiment, the special-character element is selectable to present a pop-up window that is and/or that includes the special character picker. A content producer, for example, may not know a shortcut (e.g., a keyboard shortcut) for a symbol (e.g., a section symbol “§”) and/or such a shortcut may not be available. The content producer may select the special character element to display the special character picker, may attempt to find the symbol by searching the special character picker, and if included in the special character picker, may select the symbol for insertion in to a text widget.

The show/hide source code element may be selectable to display source code, for example, of the screen displaying the show/hide source element. Selecting the show/hide source code element may, for example, display HTML code of a webpage presenting the show/hide source code element. If such code is already being displayed, for example, after a prior selection of the show/hide source code element, the show/hide source code element may be selected to hide the code.

In the depicted embodiment, the continuous-text-mode element is represented by a lotus flower. The continuous-text-mode element may be selected, for example, to present a text widget in an extended view and/or without the publication preview pane being concurrently presented. In an example scenario, a content producer may desire to create text content of a content piece by entering text while being presented a screen that includes the text widget (e.g., an extended view such as for example full screen view) and/or that may not include the publication preview pane. A content producer may select the continuous-text-mode element to be presented with a screen displaying the text widget but not displaying at least some other data-entry elements and/or the publication preview pane. An example of such a screen is depicted in FIG. 15B, which is described in more detail below. In at least one embodiment, selecting the continuous-text-mode element of a corresponding text widget causes presentation of a full-screen text editor of only that text widget. Other text widgets may be navigated to (e.g., without leaving the continuous-text mode) using the next and previous buttons.

In the depicted embodiment, the widget-split element is represented as opposite facing horizontal-line, vertical-arrow pairs. The widget-split element may be selectable, for example, to split a text widget into one or more separate text widgets. For example, a content producer may desire to separate certain text content in a single text widget from other text content in the same text widget. To separate text content in a single text widget from other text content in the same text widget, the widget-split element may be selected. Selecting the widget-split element may, for example, split a single text widget into two adjacent text widgets.

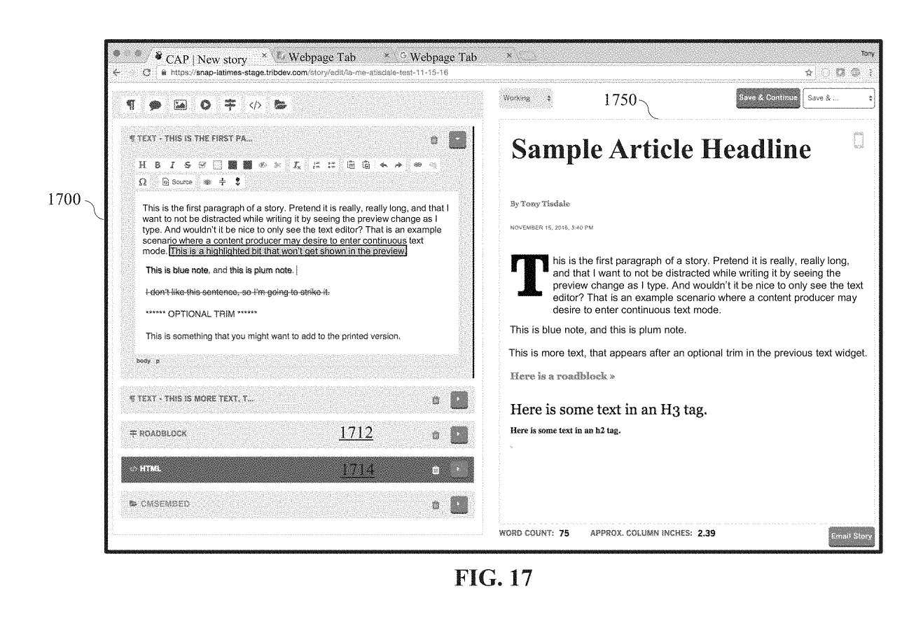

In the depicted embodiment, the merge-down element is represented as a dot with a down arrow. The merge-down element may be selectable, for example, to merge two or more text widgets into a single text widget. In at least one embodiment, the merge-down element is selectable to merge a text widget with a text widget immediately preceding and/or following the text widget. After merging two or more text widgets into a single text widget, the excess text widget(s) may be removed. For example, if, while viewing the screen of FIG. 17, a content producer selects the depicted merge-down element of the expanded text element, the two depicted text widgets may be concatenated and/or the text may be pulled from the text widget below the expanded text element (e.g., the text widget starting with “This is more text”).

Although not shown in FIG. 15A, the editing tool pane 1504 may include numerous additional and/or alternative selectable elements for performing a variety of content-production related functions. For example, two additional example selectable elements that may be included in an editing tool pane are included in the editing tool panes of FIG. 15B and FIG. 14. One additional example selectable element is a text size element (represented by the H icon) that may be selectable for modifying text size of text content presented in the publication preview pane 650.

Another additional example selected element is a trim element (represented by the scissors icon) that may be selectable for adding a trim to a printed version of the content piece. Selecting the trim element, for example, may add, to the text-area 1502, one or more line breaks and/or the text ****** OPTIONAL TRIM ******. In at least one embodiment, the text ****** OPTIONAL TRIM ****** and any text added below such text is not included in the publication preview pane 650 or the online publication of the content piece but is passed along to the PPS 116 for possible inclusion in print publication of the content piece. In at least one embodiment, selecting the trim element adds a line break, adds the text ****** OPTIONAL TRIM ****** below the line break, and adds another line break below the ****** OPTIONAL TRIM ******. Of course, the text ****** OPTIONAL TRIM ****** depicted in one or more FIGS. and described herein is for exemplary purposes only and any suitable trim indicator can be used in various different implementations.

The trash element 1506 may be selectable, for example, to delete, remove, and/or otherwise discard (e.g., temporarily), the text and/or tracked changes from the corresponding content piece. Selecting the trash element 1506 may result in the text content of the corresponding text widget to be removed as a part of a corresponding content piece, which may affect presentation of the publication preview pane 650.

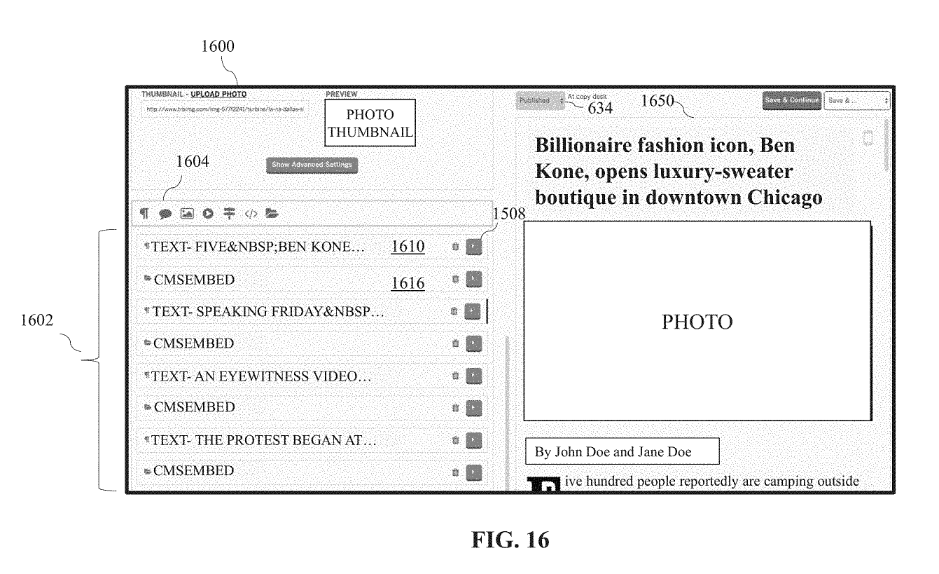

The toggle element 1508 may be selectable to, for example, toggle between an expanded form and/or a collapsed form of a widget. As described above, FIG. 15A depicts a text widget in an expanded form. FIG. 14 also depicts a text widget 1410 in expanded form. If the text widget is in an expanded form, the text widget may be changed into a collapsed form by selecting the toggle element 1508. If the text widget is in a collapsed form (as depicted in FIG. 16), then the text widget may be changed to an expanded form by selecting the toggle element 1508. In at least one embodiment, selecting the toggle element 1508 while a corresponding text widget is in an expanded form changes the text widget to a collapsed form such that the text-editing area 1502 and the text-editing tool pane 1504 become hidden. One or more other widgets (if any) of a content piece may similarly be toggled to a collapsed form. This may allow a content producer to see many and/or all of the widgets in a content piece, which in turn may allow for easier drag-and-drop operations for rearranging the widgets. Dragging and dropping widgets and rearranging widgets are discussed in more detail below with respect to FIG. 16.

FIG. 15B depicts a tenth example screenshot of the SUI presented by the CAP of FIG. 1, in accordance with at least one embodiment. The screenshot 1510 may be presented after selection of the continuous-text-mode element described above in connection with FIG. 15A. As shown in the depicted embodiment, a publication preview pane is not presented. The depicted embodiment includes similar elements as the text-editing screen of FIG. 15A, but additionally includes next button 1512, previous button 1514, exit-continuous-text-mode button 1516, and save-and-continue button 1518. In at least one embodiment, the screenshot 1510 is a screen that is presented subsequent to the continuous-text-mode element of the text widget 1410 being selected.

Next button 1512 and/or previous button 1514 may be used navigate between text widgets of the corresponding content piece. In the depicted embodiment, the next button 1512 and the previous button 1514 are dim (e.g., in comparison to the exit-continuous-text-mode button 1516 and the save-and-continue button 1518). In at least one embodiment, this is an indication that the next button 1512 and the previously button 1514 are not currently selectable. For example, if a content piece that is being assembled only includes one text widget, then there are no other text widgets to navigate to using the next button 1512 or previous buttons 1514. If there are two or more text widgets included in a content piece being assembled (e.g., as shown in FIGS. 16 and 17), then, for example, the next button 1512 may be selectable to display the text widget that follows the currently displayed text widget and/or the previous button 1514 may be selectable to display the text widget that precedes the currently displayed text widget.

FIG. 16 depicts an eleventh example screenshot of the SUI 302 presented by the CAP 104 of FIG. 1, in accordance with at least one embodiment. The screenshot 1600 of FIG. 16 includes widget-manager pane 1602 and/or widget-generation tool pane 1604. The widget-manager pane 1602 may include one or more widgets generated, for example, via the widget-generation tool pane 1604.

One or more widgets included in the widget-manager pane 1602 may be selectable and/or modifiable. Modification of a widget in the widget-manager pane 1602 may, for example, result in modification of corresponding content in the publication preview pane 1650 based on predetermined content-display rules. For example, in response to removing a widget from the widget-manager pane 1602 (e.g., by selecting the trash icon, or as a result of selecting the merge down element of a widget previously preceding the removed widget), corresponding content may be removed from the publication preview pane 1650.

In at least one embodiment, the publication preview pane 1650 presents content based on a position of one or more widgets in the widget-manager pane 1602. For example, the widget-manager pane 1602 may include two widgets, and the first widget may be positioned in a first widget-manager-pane location in the widget-manager pane 1602, and the second widget may be positioned in a second widget-manager-pane location in the widget manager pane 1602.

In such an example, the publication preview pane 1650 may present content corresponding to the first widget in a first preview-pane location based on the first-widget-manager-pane location. In such an example, the publication preview pane 1650 may present content corresponding to the second widget in a second preview-pane location based on the second-widget-manager-pane location.

In such an example, if the first widget is moved to a new location in the widget manager pane 1602 other than the first widget-manager-pane location, then at least some of the content presented in the publication preview pane 1650 may be dynamically modified based on the new location of the first widget. For example, if the first widget is moved from a first widget-manager-pane location to a new widget-manager-pane location that is below the first widget-manager-pane location, then the publication preview pane 1650 may be dynamically modified such that the first widget is presented in a new preview-pane position that is below the first preview-pane location.

The example widgets depicted in the widget-manager pane 1602 are in a collapsed form. As described above, the text-editing widget may be expanded and/or collapsed, for example, by selecting the toggle element 1508. Other widgets may be expanded and/or collapsed by selecting respective toggle elements.

The widget-generation tool pane 1604, for example, may include one or more selectable elements for generating one or more respective widgets. In the depicted embodiment, the widget-generation tool pane 1604 includes widget generating elements, listed from left to right: text widget-generation button, pull-quote widget-generation button, image widget-generation button, audio/video widget-generation button, roadblock widget-generation button, HTML widget-generation button, and CMS-embed widget-generation button. Of course, the widget-generation tool pane 1604 may include any number of additional and/or alternative widget-generation elements for generating widgets having a variety of different functions.

In at least one embodiment, to generate a widget, a selectable widget generating element is dragged from the widget-generation tool pane 1604 and/or subsequently dropped in the widget-manager pane 1602. After dragging and/or dropping the selected widget element into the widget-manager pane 1602, the corresponding generated widget may be opened so that a content producer can enter content.

In the depicted embodiment, the text-editing widget-generation button is represented as a paragraph symbol. The text-editing widget-generation button may be selectable, for example, to generate one or more text-editing widgets 1610, such as one or more text-editing widgets as described above with respect to FIG. 15A.

In the depicted embodiment, the pull-quote widget generation button is represented as a speech-bubble icon. The pull-quote widget-generation button may be selectable, for example, to generate one or more pull-quote widgets (not shown). Such one or more widgets may be configured, for example, to create pull-quotes (e.g., based on selected and/or entered text), which may be included as content of a content piece. Creating content via the one or more pull-quote widgets may cause such created content to be presented in the publication preview pane 650 in a format similar to a traditional pull-quote format. A content producer may create a pull-quote, for example, by first selecting text content in a text widget and/or subsequently selecting the pull-quote widget-generation button, which may then generate a pull-quote widget including (e.g., automatically including) the selected texted. A content producer may create a pull-quote, for example, by first selecting the pull-quote widget-generation button, which creates a pull-quote widget, and/or subsequently entering text of the pull-quote into the generated pull-quote widget.

In the depicted embodiment, the image widget-generation button is represented as an image icon. The image widget-generation button may be selectable, for example, to generate one or more image widgets (not shown). Such one or more widgets may be configured to, for example, include one or more images as content of a content piece. For example, in the image widget, a content producer may add an image which may be included as content of a content piece and/or presented in the publication preview pane. Multimedia content 806 depicted in FIG. 8 is an example of an image that was added as content using an image widget.

In the depicted embodiment, the audio/video widget-generation button is represented as a play button. The audio/video widget-generation button may be selectable, for example, to generate one or more audio/video widgets (not shown). Such one or more widgets may be configured to, for example, include one or more audio and/or video clips, files, etc. as content of a content piece.

In the depicted embodiment, the roadblock widget-generation button is represented as a guidepost icon. The roadblock widget-generation button may be selectable, for example, to generate one or more roadblocks widgets. Such one or more widgets may be configured to, for example, to create one or more roadblock links, which may be included as content of a content piece. An example roadblock widget 1712 and corresponding roadblock-widget created content are depicted in FIG. 17.

The example roadblock widget may include text (e.g., entered by a content producer) and a destination (e.g., a link to another portion of the same page or to a different page). The text included in the roadblock widget may be presented in the publication preview pane 1650 (and/or subsequently in an online-publication version and/or a print-publication version of the corresponding content piece) in such a way that sets off the text from other presented content. For example, in the depicted embodiment, the text included in the roadblock widget (“Here is a roadblock”) is presented in the publication preview pane 1650 without any text to its right. Such presented text is a selectable link to the destination that is entered in the roadblock widget. The roadblock text may additionally and/or alternatively be presented (e.g., based on the predetermined content display rules) in a different style than at least some other text content.

In the depicted embodiment, the HTML widget-generation button is represented as an HTML closing-tag icon. The HTML widget-generation button may be selectable, for example, to generate one or more HTML widgets. Such one or more widgets may be configured to, for example, allow for content of a content piece to be added by direct entry of HTML code by one or more content producers. An example HTML widget 1714 and corresponding HTML-widget created content are depicted in FIG. 17.

In the depicted embodiment, the CMS-embed widget-generation button is represented as a folder icon. The CMS-embed widget-generation button may be selectable, for example, to generate one or more CMS-embed widgets 1616. Such one or more widgets may be configured to, for example, allow for links corresponding to content created in a CMS (e.g., the CMS 118) to be included as content of a content piece. For example, content producers can create content such as, for example, photo galleries, videos, stories, and/or HTML stories, among other content, which can be linked from a CMS via the CMS-embed widget. The CMS may be configured to determine how these links (e.g., a single photo for a photo gallery and/or a headline/thumbnail for an article) are ultimately presented. In at least one embodiment, the publication preview pane does 1650 not show content linked to via the CMS-embed widget. For example, instead of the publication preview pane displaying one or more actual photos of a photo gallery linked via the CMS-embed widget, the publication preview pane may display a placeholder for the one or more actual photos.

In the depicted embodiment, the story-status widget 634 is set to “published”. After a content piece is published online, the content piece may need to be updated for a variety of different reasons. In at least one embodiment, the story-status widget 634 is selectable to be changed from a value of “published” to “updating” (and vice versa). For example, while viewing the screenshot 1700, a content producer may select the story-status widget 634 to change the value of the story-status widget 634 from “published” to “updating”. The content producer may then make changes to the previously published content and the content piece may then be republished. In at least one embodiment, changes made to previously published content while the story-status widget 634 is set to “updating” will not be saved until the story-status widget 634 is switched from “updating” to “published”. This may allow one or more content producers to work on a live breaking news story and to publish the changes only when ready.

FIG. 17 depicts a twelfth example screenshot of the SUI 302 presented by the CAP 104 of FIG. 1, in accordance with at least one embodiment. The example screenshot 1700 includes many elements described above with respect to other FIGS. and are not described again here. The depicted embodiment includes two text widgets (one widget depicted in expanded form and one widget depicted in closed form), a roadblock widget, an HTML widget, and a CMSEMBED widget. In the depicted embodiment, content included in the respective widgets are presented in the publication preview pane 1750 according to an arrangement of the widgets in the widget-manager pane. For example, the arrangement of the widgets (from top of the screenshot to bottom of the screenshot) is reflected in the arrangement of corresponding content presented in the publication preview pane 1750. The expanded text widget, which appears as the first widget (from top to bottom) includes content presented first in the publication preview pane 1750 (as compared to content corresponding to the other depicted widgets).

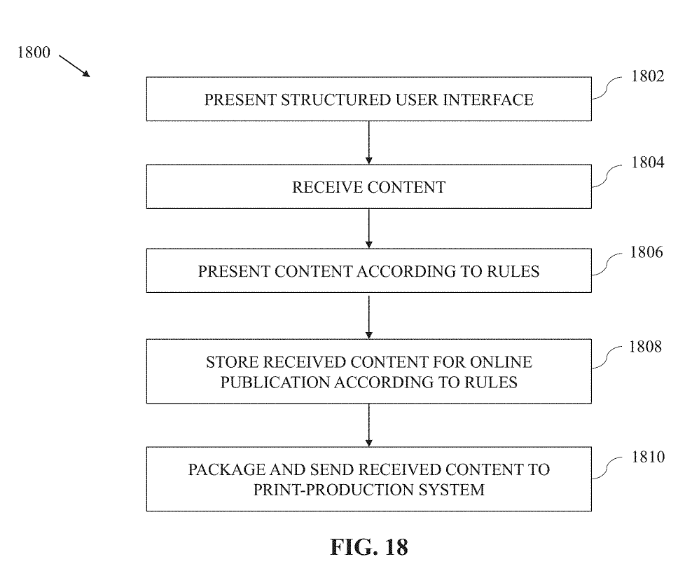

FIG. 18 depicts an example method, in accordance with at least one embodiment. In at least one embodiment, the example method 1800 of FIG. 18 is carried out by the CAP 104 executing stored program instructions.

At step 1802, a structured user interface is presented. For example, the CAP 104 may present the structured user interface 302 which may be arranged for structured receipt of authored content. In at least one embodiment, the CAP 104 presents the structured user interface 302 on one or more of the client devices 106-114. Examples of such presentation of a structured user interface is further described above in connection with descriptions of various screenshots.

At step 1804, content is received. For example, the CAP 104 may receive content for a content piece via the SUI 302. In at least one embodiment, the CAP 104 receives content entered through the SUI 302 via the optional user interface 210 of one or more of the client devices 106-114. The SUI 302 may include, for example, separate first and second regions (e.g., the first region 502 of FIG. 5 and/or the second region 504 of FIG. 5). The first region may include, for example multiple data-entry elements (e.g., the multiple data-entry elements 512 of FIG. 5) for respectively receiving different aspects of the content piece.

At step 1806, content is presented according to rules. For example, the CAP 104 may present content (e.g., the content received at step 1804) via the structured user interface 302 according to a set of predetermined content-display rules. The received content may be, for example, uneditably presented in the second region according to the predetermined content-display rules.

In at least one embodiment, a messaging application is integrated with the structured user interface. One or more workflow commands, for example, may be received via the structured user interface. In response to receiving the workflow command via the structured user interface, an associated workflow message, for example, may be transmitted via the integrated messaging application. In response to receiving the workflow command via the structured user interface, the associated workflow message, for example, may be transmitted via the integrated messaging application via a content-appropriate channel provided by the integrated messaging application.

At step 1808, received content is stored for online publication according to rules. For example, received content (e.g., the content received at step 1804) is stored in a content management system (CMS) (e.g., CMS 118) for online publication of a content piece according to a set of predetermined content-display rules (e.g., that are the same as or similar to the set of predetermined content-display rules at step 1806).

In at least one embodiment, the structured user interface interacts with the CMS via a CMS-agnostic application programming interface (API). As such, embodiments of the CAP are designed and programmed so as to provide a CMS-agnostic API for integration with various different CMS implementations. Design and construction of an API for a given programmed entity such that the programmed entity is compatible with multiple different other entities via the API is within the skill of those in the programming arts, and in general makes use of known programming techniques such as encapsulation of functionality within a defined and documented interface.

At step 1810, received content is packaged and sent to a print-production system. For example, the CAP 104 may receive an instruction to publish the content piece to a print-production system (e.g., the PPS 116), and/or may responsively package the received content in a print-production-system-readable format and transmit the packaged content to the print-production system. The CAP 104 may responsively (a) package the received content in the print-production-system-readable format and (b) transmit the package content to the print-production system, for example, multiple iterative times to provide rolling updates of the content piece to the print-production system.

Each rolling update may include, for example, a complete copy of the updated content piece. For example, a first rolling update provided to the PPS may include a first complete copy of a content piece after one or more first updates, and/or a second rolling update provided to the PPS may include a second complete copy of the content piece after one or more second updates. In this example, both the first complete copy and the second complete copy are complete copies of the content piece provided to the PPS in respective rolling updates; however, the first complete copy and the second complete copy (in a scenario where the one or more first updates are different from the one or more second updates) each represent a different version of the complete content piece during the content assembly process. For example, the first rolling update including the first complete copy of the content piece may be provided after the first complete copy is ready for print-publication.

Subsequent to providing the PPS with the first rolling update including the first complete copy of the content piece, one or more changes may be made to the content piece and/or data associated with the content piece (e.g., a first date planned for the content piece to print-publish, for example, entered into the PPS-planning-date field 804). With the second rolling update, the second complete copy of the content piece, which (in this example) represents the version of the content piece with the implemented one or more changes (e.g., an updated date planned for the content piece to print-publish, for example, entered into the PPS-planning-date field 804 in place of the first date planned), may be provided to the PPS.

What is claimed is:

1. A method carried out by a content assembly platform (CAP), the method comprising:
presenting a structured user interface (SUI) arranged for structured receipt of authored content, the SUI including an integrated messaging application;
receiving content for a content piece via the SUI;
presenting the received content via the SUI according to a set of predetermined content-display rules;
storing the received content in a content management system (CMS) for online publication of the content piece according to the set of predetermined content-display rules; and
receiving an instruction to publish the content piece to a print-production system (PPS), and responsively packaging the received content in a PPS-readable format and transmitting the packaged content to the PPS.

2. The method of claim 1, wherein:
the SUI includes separate first and second regions;
the first region includes multiple data-entry elements for respectively receiving different aspects of the content piece, the multiple data-entry elements including at least one data-entry field and at least one data-entry widget; and
the received content is uneditably presented in the second region according to the predetermined content-display rules.

3. The method of claim 1 further comprising receiving a workflow command via the SUI, and responsively transmitting an associated workflow message via a content-appropriate channel of the integrated messaging application.

4. The method of claim 1, further comprising:
obtaining an integrated-messaging-application-generated token for user authentication; and
authenticating a user with the integrated messaging application one or more times using the obtained token.

5. The method of claim 1, wherein each content piece is uniquely identified within the CAP by a unique identifier, the unique identifier including at least an alphanumeric slug conforming to a workflow-shaping convention.

6. The method of claim 1, further comprising receiving a trim indication for the content piece via the SUI, wherein packaging the received content in the PPS-readable format comprises including the received trim indication in the packaged content.

7. The method of claim 1, wherein the CAP carries out the packaging and transmitting steps iteratively so as to provide rolling updates of the content piece to the PPS.

8. The method of claim 1, further comprising receiving a print-production-sever command via the SUI and responsively transmitting a print-production-severed instruction to the PPS.

9. The method of claim 1, wherein the SUI is configured to receive identifiers of audio and/or visual content items for embedding in the content piece.

10. A content assembly platform (CAP) configured to:
output for presentation a structured user interface (SUI) arranged for structured receipt of authored content;
receive content for a content piece via the SUI;
output for presentation the received content via the SUI according to a set of predetermined content-display rules;
submit the received content in a content management system (CMS) for online publication of the content piece according to the set of predetermined content-display rules; and
receive an instruction to publish the content piece to a print-production system (PPS), and responsively package the received content in a PPS-readable format and transmit the packaged content to the PPS.

11. A content assembly platform (CAP) comprising:
a controller module;
a print production system (PPS) communication module;
a structured user interface (SUI) module configured to:
present a SUI arranged for structured receipt of authored content, the SUI configured to receive identifiers of audio and/or visual content items for embedding in the content piece;
receive content for a content piece via the SUI;
present the received content via the SUI according to a set of predetermined content-display rules; and
provide the received content to the controller module; and
a content management system (CMS) communication module configured to:
receive the received content from the controller module; and
transmit the received content to a CMS for online publication of the content piece according to the set of predetermined content-display rules, wherein the controller module is configured to:
receive the received content from the SUI module;
provide the received content to the CMS communication module; and
receive an instruction to publish the content piece to a PPS, and
responsively provide the received content to the PPS communication module, wherein the PPS communication module is configured to responsively:
receive the received content from the controller module;
package the received content in a PPS-readable format, including at least XML; and
transmit the packaged content to the PPS.

12. The CAP of claim 11, wherein:
the SUI includes separate first and second regions;
the first region includes multiple data-entry elements for respectively receiving different aspects of the content piece, including at least a data-entry field and a data-entry widget; and
the SUI module is configured to uneditably present the received content in the second region according to the predetermined content-display rules.

13. The CAP of claim 12, wherein:
the CAP further includes a messaging application (MA) communication module integrated with the SUI module;
the SUI module is further configured to receive a workflow command via the SUI;
the controller module is further configured to receive the received workflow command from the SUI module and responsively provide the received workflow command to the MA communication module; and
the MA communication module is configured to responsively transmit an associated workflow message via the integrated messaging application.

14. The CAP of claim 13, wherein the MA communication module is configured to transmit the associated workflow message via the integrated messaging application includes the MA communication module being configured to transmit the associated workflow message via a content-appropriate channel of the integrated messaging application.

15. The CAP of claim 12, wherein the MA communication module is configured to:
obtain an integrated-messaging-application-generated token for user authentication; and
authenticate a user with the integrated messaging application one or more times using the obtained token.

16. The CAP of claim 11, wherein each content piece is uniquely identified within the CAP by a unique identifier, the unique identifier including at least one alphanumeric slug conforming to a workflow-shaping convention, each alphanumeric slug for a given content piece identifying a corresponding news desk for the given content piece.

17. The CAP of claim 11, wherein:
the SUI module is further configured to receive a trim indication for the content piece via the SUI, and
the PPS communication module is further configured to include the received trim indication in the packaged content.

18. The CAP of claim 17, wherein the PPS communication module is further configured to use Simple Object Access Protocol (SOAP) communication to transmit the packaged content to the PPS.

19. The CAP of claim 11, wherein:
the SUI is further configured to receive a print-production-sever command via the SUI, and
the PPS communication module is further configured to responsively transmit a print-production-severed instruction to the PPS.

20. The CAP of claim 11, wherein the SUI is configured to receive identifiers of audio and/or visual content items for embedding in the content piece.
